(19) United States
(12) Patent Application Publication
(10) Pub. No.: US 2024/0362404 A1
(43) Pub. Date: Oct. 31, 2024

(54) ARTIFICIAL INTELLIGENCE-BASED AUTOMATED REPORT GENERATOR

(71) Applicant: HeyWire AI, Inc., Monrovia, CA (US)

(72) Inventors: Vafa Von Raees, Monrovia, CA (US); Samuel James Kubert, Monrovia, CA (US)

(21) Appl. No.: 18/308,854

(22) Filed: Apr. 28, 2023

(51) Int. Cl. G06F 40/166; G06F 40/20; G06N 3/08

(52) U.S. Cl. CPC G06F 40/166; G06F 40/20; G06N 3/08; G06F 3/04847

(57) ABSTRACT

Systems and methods for generating a report, including acquiring data for topics of interest from a plurality of data sources. Content from the acquired data is extracted, prioritized, and categorized into corresponding categories and subcategories based on a predetermined hierarchical set of priority rules, and a writing style and report threshold levels are selected as constraints for generating a customized report based on the prioritized and categorized content. A final report draft can be iteratively generated by generating report drafts by sequentially utilizing the prioritized and categorized content from a highest priority level to a lowest priority level for the categories and subcategories until one or more report threshold level constraints are reached. An overall quality score for the final report draft is determined based on a category content accuracy score for each of the categories determined by calculating an average of subcategory content accuracy scores for each related subcategory.

### BACKGROUND

### Technical Field

The present invention relates to an artificial intelligence-based automated report/news article generator, and more particularly to an artificial intelligence-based automated data crawler/data scraper and report/news article generator with a graphical user interface dashboard and controller.

### Description of the Related Art

News organizations currently require employment of investigative news staff, writing staff, and support staff (e.g., editors, photographers, etc.) for researching and/or writing reports (e.g., news articles). Such staff members are generally burdened with low-impact generic reporting (e.g., traffic reports, local crime reports, weather reports, etc.) rather than being able to spend their time and resources for unique and/or breaking investigative journalism and high-quality report/news article generation. This is due at least in part to the high volume of newsworthy content, near real-time reporting requirements (e.g., to get a “scoop” on other news organizations for breaking news), and limited human resources to perform the required work for researching and writing news reports. This lack of time and resources is also due at least in part to the cost of employing such a large number of staff members, and the demand of the public for such generic reports/news articles regarding mundane, yet at least locally important news content. However, high-quality reports/news articles generally translates to additional readers and thus, profits for the news organizations. Thus, a need exists for a low-cost, automated, accurate report/news article generator capable of generating high-quality report/news articles for any of a plurality of topics (e.g., generic news reporting, unique/breaking news investigative reporting, sports reporting, etc.).

### SUMMARY

According to an aspect of the present invention, a method is provided for generating a report, including acquiring data for topics of interest from a plurality of data sources. Content from the acquired data is extracted, prioritized, and categorized into corresponding categories and subcategories based on a predetermined hierarchical set of priority rules, and a writing style and report threshold levels are selected as constraints for generating a customized report based on the prioritized and categorized content. A final report draft can be iteratively generated by generating report drafts by sequentially utilizing the prioritized and categorized content from a highest priority level to a lowest priority level for the categories and subcategories until one or more report threshold level constraints are reached. An overall quality score for the final report draft is determined based on a category content accuracy score for each of the categories determined by calculating an average of subcategory content accuracy scores for each related subcategory.

According to another aspect of the present invention, a system is provided for generating a report, including a processor operatively coupled to a computer-readable storage medium, the processor configured for acquiring data for topics of interest from a plurality of data sources. Content from the acquired data is extracted, prioritized, and categorized into corresponding categories and subcategories based on a predetermined hierarchical set of priority rules, and a writing style and report threshold levels are selected as constraints for generating a customized report based on the prioritized and categorized content. A final report draft can be iteratively generated by generating report drafts by sequentially utilizing the prioritized and categorized content from a highest priority level to a lowest priority level for the categories and subcategories until one or more report threshold level constraints are reached. An overall quality score for the final report draft is determined based on a category content accuracy score for each of the categories determined by calculating an average of subcategory content accuracy scores for each related subcategory.

A non-transitory computer readable storage medium including a computer readable program operatively coupled to a processor device for generating a report, including acquiring data for topics of interest from a plurality of data sources. Content from the acquired data is extracted, prioritized, and categorized into corresponding categories and subcategories based on a predetermined hierarchical set of priority rules, and a writing style and report threshold levels are selected as constraints for generating a customized report based on the prioritized and categorized content. A final report draft can be iteratively generated by generating report drafts by sequentially utilizing the prioritized and categorized content from a highest priority level to a lowest priority level for the categories and subcategories until one or more report threshold level constraints are reached. An overall quality score for the final report draft is determined based on a category content accuracy score for each of the categories determined by calculating an average of subcategory content accuracy scores for each related subcategory.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 shows an exemplary processing system to which the present principles may be applied, in accordance with embodiments of the present invention;

FIG. 2 is a block/flow diagram showing a high-level system and method for artificial intelligence-based data collection, analysis, and automated report/news article generation using a neural network and content captured from a plurality of data sources, in accordance with embodiments of the present invention;

FIG. 3 is a block/flow diagram showing a method for artificial intelligence-based automated report/news article generation and optimization using a neural network and Natural Language Processing (NLP) techniques to analyze content captured from a plurality of data sources, in accordance with embodiments of the present invention;

FIG. 4 is a block/flow diagram showing a method for report/news article generation including acquiring, prioritizing, and weighting acquired data related to one or more topics of interest from a plurality of data sources, in accordance with embodiments of the present invention;

FIG. 5 is a block/flow diagram showing a method for report/news article generation by determining relevant data for including in the report/news article based on an analysis of acquired data related to one or more topics of interest from a plurality of data sources, in accordance with an embodiment of the present invention;

FIG. 6A is a block/flow diagram showing a system and method for creating and/or selecting a report/news article writing style for generating a report/news article, in accordance with an embodiment of the present invention;

FIG. 6B is a block/flow diagram showing a system and method for creating and/or selecting a report/news article writing style for generating a report/news article, in accordance with an embodiment of the present invention;

FIG. 6C is a block/flow diagram showing a system and method for creating and/or selecting a report/news article writing style for generating a report/news article, in accordance with an embodiment of the present invention;

FIG. 7A is a diagram showing an exemplary writing style/personality graph for creating and/or selecting a report/news article writing style for generating a report/news article, in accordance with embodiments of the present invention;

FIG. 7B is a diagram showing an exemplary writing style/personality graph for creating and/or selecting a report/news article writing style for generating a report/news article, in accordance with embodiments of the present invention;

FIG. 7C is a diagram showing an exemplary writing style/personality graph for creating and/or selecting a report/news article writing style for generating a report/news article, in accordance with embodiments of the present invention;

FIG. 8 is a generalized diagram showing an exemplary neural network for artificial intelligence-based data analysis, automated report/news article generation, and optimization, in accordance with embodiments of the present invention;

FIG. 9 is a hardware diagram showing an exemplary artificial neural network (ANN) for artificial intelligence-based data analysis, automated report/news article generation, and optimization, in accordance with embodiments of the present invention;

FIG. 10 is a block diagram showing an exemplary neuron in a neural network for artificial intelligence-based automated data analysis, report/news article generation, and optimization, in accordance with embodiments of the present invention;

FIG. 11 is a diagram showing an exemplary layered neural network for artificial intelligence-based automated data analysis, report/news article generation, and optimization, in accordance with embodiments of the present invention; and

FIG. 12 is a block diagram showing a system for artificial intelligence-based data collection, analysis, optimization, and automated report/news article generation using a neural network and content acquired from a plurality of data sources, in accordance with embodiments of the present invention.

### DETAILED DESCRIPTION

In accordance with embodiments of the present invention, systems and methods are provided for artificial intelligence-based data collection, analysis, optimization, and automated report/news article generation using a neural network and content acquired from a plurality of data sources.

In various embodiments, the present invention can include a low-cost, automated, accurate report/news article generator capable of generating high-quality report/news articles for any of a plurality of topics (e.g., generic news reporting, unique/breaking news investigative reporting, sports reporting, etc.) from any of a plurality of local and/or remote data sources.

In various embodiments, the inventive systems and methods described hereinbelow address the above-mentioned deficiencies of conventional systems and methods, and can acquire and/or analyze data (e.g., online news reports, blog posts, social media posts, scientific paper databases, audio podcasts, video clips, etc.) regarding one or more topics of interest for writing a report/news article. In one embodiment, the data can be graded/prioritized/weighted in view of custom-created, or default categories and/or subcategories (e.g., six (6) journalistic questions (e.g., Who, What, Where, When, Why, How)) for searching and analysis of acquired data. Each question can be color coded (or the like) for satisfaction of a threshold condition for each of the above exemplary journalistic questions.

In some embodiments, for example, red can indicate that the system cannot find more than 30% of answers to one or more of the questions, Yellow can indicate that the system cannot find over 70% of the answers to one or more of the questions, and green can indicate that the system can find over 70% of the answers to one or more of the questions. This categorization and analysis can be executed using Natural Language Processing (NLP) techniques, which can include, for example, Natural Language Understanding (NLU), sentiment analysis, named entity recognition, summarization, topic modeling, text classification, keyword extraction, lemmatization and stemming, etc., in accordance with various aspects of the present invention. The data can be preprocessed and trained using a neural network, and can further be iteratively trained and optimized to improve search, analysis, and report/news article generation capabilities.

In some embodiments, priority can denote how much of the question is to be answered by the data acquired for particular prioritized categories and/or subcategories. For example, priority 2 can represent half of priority 1, and priority 3 can represent half of priority 2, and this priority list threshold can continue to be halved in weight up to a threshold priority level (e.g., priority 10). The above prioritized data threshold satisfaction and data analysis can be individually calculated for acquired data for any of a plurality of topics from any of a plurality of data sources such that the total data acquired can fulfill the answer to the one or more questions to a 100% combined level. Priority weights can be adjusted and/or can automatically change within categories, and/or add categories and define weights to further customize the report/news article generated, in accordance with aspects of the present invention.

In some embodiments, a percentage of word count specified for categories and/or subcategories (e.g., Who, What, Why, etc.) for a particular story (or story tier level) can be user-specified (or preset default percentages for story tier levels/types), and can be utilized in addition to, or in lieu of the quality thresholds described above to determine whether sufficient information from particular categories and/or subcategories has been acquired prior to and/or during generation of a report/news article, in accordance with aspects of the present invention.

As will be appreciated by one skilled in the art, aspects of the present invention may be embodied as a system, method or computer program product, which can be executed on local and/or remote computing devices. Accordingly, aspects of the present invention may take the form of an entirely hardware embodiment, an entirely software embodiment (including firmware, resident software, micro-code, etc.) or an embodiment combining software and hardware aspects. Furthermore, embodiments of the present invention may take the form of a computer program product embodied in one or more computer readable medium(s) on one or more computing devices having computer readable program code embodied thereon. Embodiments described herein may be entirely hardware, entirely software or including both hardware and software elements. In some embodiments, the present invention is implemented in software, which includes but is not limited to firmware, resident software, microcode, etc., in accordance with aspects of the present invention.

Any combination of one or more computer readable medium(s) may be employed. The computer readable medium may be a computer readable signal medium or a computer readable storage medium. A computer readable storage medium may be, but is not limited to, an electronic, magnetic, optical, electromagnetic, infrared, or semiconductor system, apparatus, or device, or any combination thereof. Other examples of the computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any combination thereof. In this document, a computer readable storage medium may be any tangible medium that can contain, or store a program for use by or in connection with a computing system, apparatus, or device.

Program code embodied on a computer readable medium may be transmitted using any suitable medium, including but not limited to wireless, wireline, optical fiber cable, etc., or any combination thereof. Computer program code for carrying out operations for aspects of the present invention may be written in any combination of one or more programming languages, including, but not limited to any general-purpose programing language (e.g., PHP, Java, C++, etc.) and/or domain-specific programing language (e.g., HTML, SQL, etc.), blockchain-specific programming language (e.g., solidity, rust, java, python, etc.). The program code may execute fully on the user's computer/mobile device, partially on the user's computer/mobile device, as stand-alone software, partially on the user's computer/mobile device and partially on a remote computer/mobile device, entirely on a remote computer or server, and/or using blockchain. The remote computer may be connected to the user's computer through any type of network (e.g., a local area network (LAN), wide area network (WAN), a connection to an external computer (e.g., over the Internet using an Internet Service Provider), etc.).

Aspects of the present invention are described below with reference to flowchart illustrations and/or block diagrams of methods, systems and computer program products according to embodiments of the present invention. It is noted that each block of the flowcharts and/or block diagrams, and combinations of blocks in the flowcharts and/or block diagrams, may be implemented by computer program instructions.

These computer program instructions may be sent to a processor of any type of computing system (e.g., general purpose computer, special purpose computer, or other programmable data processing apparatus to produce a machine), such that the instructions, which execute by the processor of the computing system, create a means for implementing the functions/instructions/acts specified in the flowcharts and/or block diagram block or blocks. These computer program instructions may also be stored in a computer readable medium that can instruct any computing device to function in a particular manner, such that the instructions stored in the computer readable medium produce an article of manufacture including instructions which implement the function/instruction/act specified in the flowchart and/or block diagram block or blocks.

The computer program instructions may also be loaded onto a computer, mobile device, other programmable data processing apparatus, or other devices to cause a series of operational steps to be performed on any computing system to produce a computer implemented process such that the instructions which execute on the computer or other programmable apparatus provide processes for implementing the functions/acts specified in the flowcharts and/or block diagram block or blocks.

A computer readable signal medium may include a propagated data signal with computer readable program code embodied therein (e.g., baseband, part of a carrier wave, etc.). Such a propagated signal may take any of a variety of forms, including, but not limited to, electro-magnetic, optical, or any combination thereof. A computer readable signal medium may be any computer readable medium that is not a computer readable storage medium and that can communicate, propagate, or transport a program for use by or in connection with a computing system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems, remote printers, storage devices, blockchain, etc. through intervening private or public networks. Modems, cable modem and Ethernet cards are just a few of the currently available types of network adapters.

The flowchart and block diagrams in the figures illustrate the architecture, functionality, and operation of possible implementations of systems, methods and computer program products according to various embodiments of the present invention. Each block in the flowchart or block diagrams may represent a module, segment, or portion of code, which comprises one or more executable instructions for implementing the specified logical function(s), and in some alternative implementations of the present invention, the functions noted in the block may occur out of the order noted in the figures. For example, two blocks shown in succession may, in fact, be executed substantially concurrently, may sometimes be executed in reverse order, or may be executed in any other order, depending on the functionality of a particular embodiment.

It is also noted that each block of the block diagrams and/or flowchart illustration, and combinations of blocks in the block diagrams and/or flowchart illustration, can be implemented by specific purpose hardware systems that perform the specific functions/acts, or combinations of special purpose hardware and computer instructions according to the present principles.

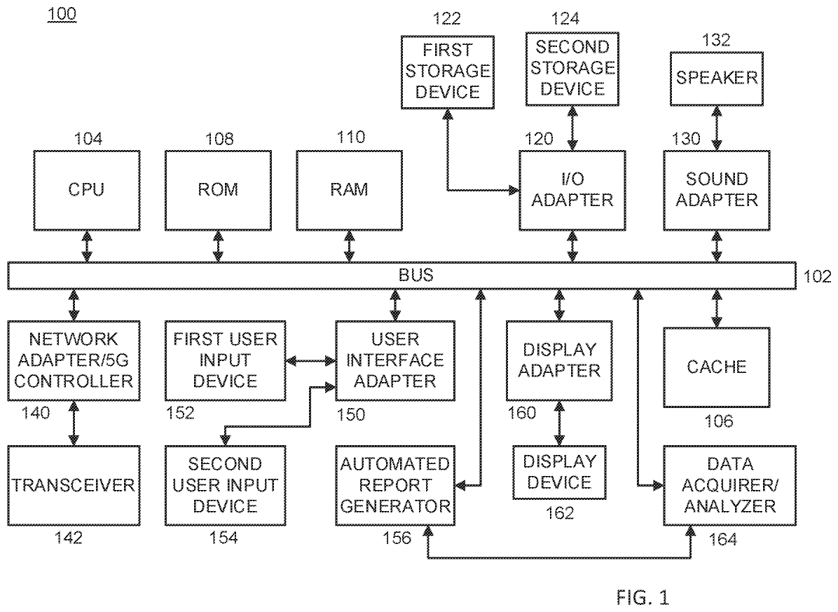

Referring now to the drawings in which like numerals represent the same or similar elements and initially to FIG. 1, an exemplary processing system 100, to which the invention principles may be applied, is illustratively depicted in accordance with embodiments of the present invention. The processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, can be operatively coupled to the system bus 102.

A first storage device 122 and a second storage device 124 can be operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 can be operatively coupled to system bus 102 by the sound adapter 130. The speaker 132 can be used to provide an audible alarm or some other indication relating to resilient battery charging in accordance with the present invention. A transceiver 142 can be operatively coupled to system bus 102 by network adapter 140. A display device 162 can be operatively coupled to system bus 102 by display adapter 160.

A first user input device 152 and a second user input device 154 can be operatively coupled to system bus 102 by user interface adapter 150. The user input devices 152, 154 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154 can be the same type of user input device or different types of user input devices. The user input devices 152, 154 can be used to input and output information to and from system 100. The system 100 can acquire data for one or more topics of interest using a web crawler/scraper, and analyze the data using Natural Language Processing (NLP), which can include Natural Language Understanding (NLU) and/or other NLP techniques using a data acquirer/analyzer in block 164, and can automatically generate one or more reports using an automated report/news article generator in block 156, in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

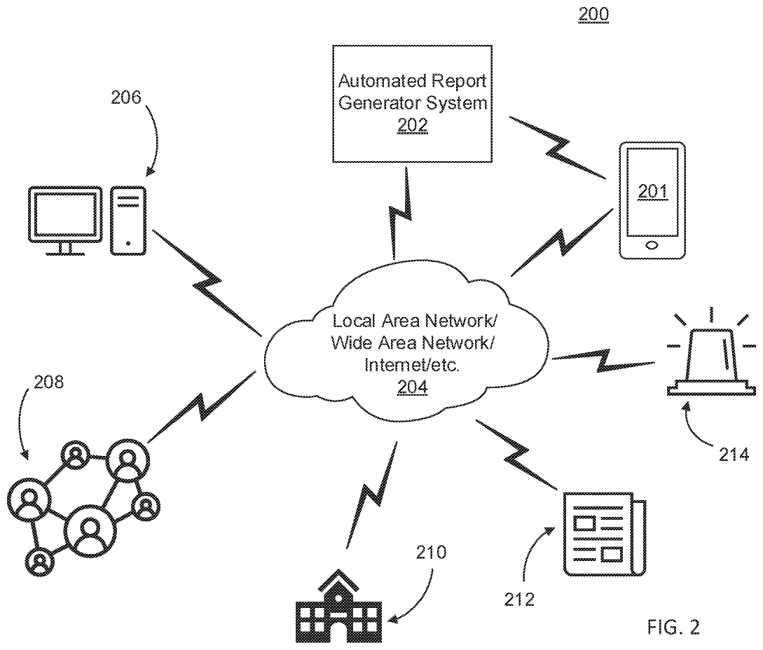

Moreover, it is to be appreciated that systems 200, 600, 800, 900, 1000, 1100, and 1200, described below with respect to FIGS. 2, 6, 8, 9, 10, 11, and 12, respectively, are systems for implementing respective embodiments of the present invention. Part or all of processing system 100 may be implemented in one or more of the elements of systems 200, 600, 800, 900, 1000, 1100, and 1200 of FIGS. 2, 6, 8, 9, 10, 11, and 12, respectively.

Further, it is to be appreciated that processing system 100 may perform at least part of the methods described herein including, for example, at least part of methods 200, 300, 400, 500, 600, 700, and 800 of FIGS. 2, 3, 4, 5, 6, 7, and 8, respectively. Similarly, part or all of systems 200, 600, 800, 900, 1000, 1100, and 1200 of FIGS. 2, 6, 8, 9, 10, 11, and 12, respectively, may be used to perform at least part of methods 200, 300, 400, 500, 600, 700, and 800 of FIGS. 2, 3, 4, 5, 6, 7, and 8, respectively.

Referring now to FIG. 2, a block/flow diagram showing a high-level system and method 200 for artificial intelligence-based data collection, analysis, and automated report/news article generation using a neural network and content captured from a plurality of data sources, is illustratively depicted in accordance with an embodiment of the present invention.

In some embodiments, the present invention can acquire data for any selected topic(s) of interest from any of a plurality of sources using an automated report/news article generator system 202, which can acquire data using, for example, a web crawler, web scraper, database or direct web search using Natural Language Processing (NLP), Natural Language Understanding (NLU), etc., in accordance with aspects of the present invention.

In various embodiments, the system 202 can acquire data (e.g., collect or receive data) from any of a plurality of remote or local data sources by connecting to a local area network, wide area network, Internet, etc. 204. The data sources can include, but are not limited to, local or remote user devices 201 (e.g., smart phone, laptop, desktop, tablet, etc.), which can be connected directly or remotely to the system 202 for data analysis and/or report/news article generation, local or remote database servers 206, social media postings 208 (e.g., textual, pictural, video, etc.), Educational institutions 210 (e.g., scientific paper database, legal writing database, school events bulletin, etc.), news organizations 212 (e.g., print, online, television, etc.), emergency services reports 214 (e.g., police/fire scanner, “Wanted” person public database, arrest/crime reports, etc.), and any other appropriate data sources for use in acquiring data for a particular topic of interest for generating a report/news article, in accordance with various aspects of the present invention.

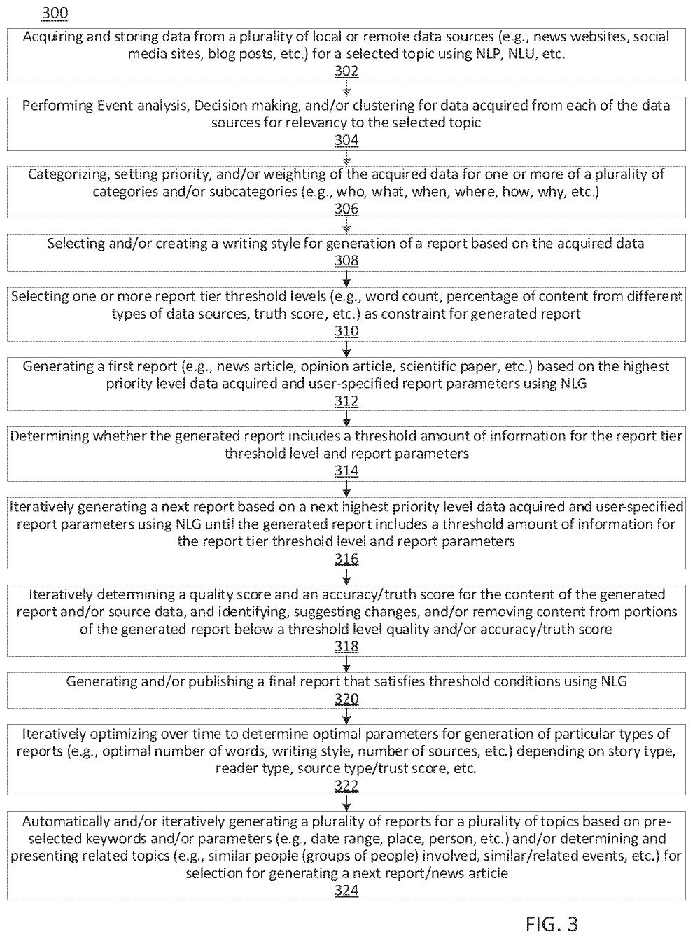

Referring now to FIG. 3, a block/flow diagram showing a method 300 for artificial intelligence-based automated report/news article generation and optimization using a neural network and Natural Language Processing (NLP) techniques to analyze content captured from a plurality of data sources, is illustratively depicted in accordance with an embodiment of the present invention.

In various embodiments, in block 302, data for one or more selected topics of interest can be identified and/or acquired (e.g., using web crawler, web scraper, database searcher, etc.) and stored (e.g., locally and/or remotely) from any of a plurality of local and/or remote data sources (e.g., news websites, social media sites, blog posts, etc.) using Natural Language Processing (NLP) techniques, which can include, for example, Natural Language Understanding (NLU), sentiment analysis, named entity recognition, summarization, clustering, topic modeling, text classification, keyword extraction, lemmatization and stemming, etc., in accordance with various aspects of the present invention. In block 304, event analysis, decision making, and/or clustering can be performed using data acquired from each of the data sources to determine relevancy, verify a threshold amount of data is acquired for the selected topic(s) of interest, and to reduce processing requirements and increase speed of analysis of acquired data at least in part due to prevention of data explosion (e.g., rapid or exponential increase in the amount of data that is acquired, generated, and/or stored in the computing systems, that reaches level where data management becomes difficult and thus computationally inefficient using conventional systems and methods) by clustering of data, in accordance with aspects of the present invention.

In block 306, the acquired data can be categorized, prioritized, and/or weighted for one or more of a plurality of question categories and/or subcategories (e.g., Who, What, When, Where, How, Why, etc.) relevant to any of a plurality of topics of interest (e.g., current events, science, technology, sports, politics, breaking news, public figures, etc.), which can be selected by a user, in accordance with aspects of the present invention. In some embodiments, the data priority/weighting list can be created and/or utilized by an end user (e.g., using a graphical user interface (GUI) controller) to prioritize and/or weight one or more data sources, data types, and/or content determined to be most relevant and/or most appropriate to include in a automatically generated report/news article in block 306 by training and/or using a pre-trained or iteratively trained neural network (e.g., artificial neural network (ANN), recurrent neural network (RNN), bidirectional, etc.), which will be described in further detail herein below.

For illustrative purposes, an exemplary priority list can include, for example, one or more of the following default categories/subcategories for prioritizing and/or weighting acquired data for event analysis in block 304, noting that priority levels, categories, subcategories, etc. can be customized by an end user using a GUI:
I. Who—Priority 1
   1. Individuals directly Involved—Priority 1
      A. Individual's details
         i. Names—Priority 1
         ii. Affiliation—Priority 3
         iii. Age—Priority 3
         iv. Residence—Priority 5
         V. Location—Priority 2
         vi. Origin—Priority 4
         vii. Experience—Priority 7
         viii. Titles—Priority 6
         ix. Public legal record—Priority 5
   2. Organizations directly involved—Priority 2
      A. Type of Organization—Priority 3
      B. Mission—Priority 2
      C. Vision—Priority 8
      D. Leadership names—Priority 3
      E. Organization Affiliation—Priority 2
      F. When the organization was founded—Priority 7
      G. Where the organization operates—Priority 4
      H. Organization headquarters Location—Priority 5
   3. Groups directly involved—Priority 3
      A. Type of Group—Priority 2
      B. Mission—Priority 3
      C. Leadership names—Priority 4
      D. Group Affiliation—Priority 2
      E. When the group originated—Priority 6
      F. Where the group originated—Priority 7
      G. Where the group currently operates—Priority 3
      H. Culture—Priority 4
      I. Religions—Priority 4
   4. Impact—Priority 4
      A. Individuals directly Affected—Priority 1
         i. Individual's details
         a. Names—Priority 1
         b. Affiliation—Priority 3
         c. Age—Priority 3
         d. Residence—Priority 5
         e. Location—Priority 2
         f. Origin—Priority 4
         g. Experience—Priority 7
         h. Titles—Priority 6
         i. Public legal record—Priority 5
      B. Organizations directly Affected—Priority 2
         i. Type of Organization—Priority 3
         ii. Mission—Priority 2
         iii. Vision—Priority 8
         iv. Leadership names—Priority 3
         v. Organization Affiliation—Priority 2
         vi. When the organization was founded—Priority 7
         vii. Where the organization operates—Priority 4
         viii. Organization headquarters Location—Priority 5
      C. Groups directly Affected—Priority 3
         i. Type of Group—Priority 2
         ii. Mission—Priority 3
         iii. Leadership names—Priority 4
         iv. Group Affiliation—Priority 2
         v. When the group originated—Priority 6
         vi. Where the group originated—Priority 7
         vii. Where the group currently operates—Priority 3
         viii. Culture—Priority 4
         ix. Religions—Priority 4
      D. Individuals indirectly Affected—Priority 4
         i. Individual's details
         a. Names—Priority 1
         b. Affiliation—Priority 3
         c. Age—Priority 3
         d. Residence—Priority 5
         e. Location—Priority 2
         f. Origin—Priority 4
         g. Experience—Priority 7
         h. Titles—Priority 6
         i. Public legal record—Priority 5
      E. Organizations indirectly Affected—Priority 5
         i. Type of Organization—Priority 3
         ii. Mission—Priority 2
         iii. Vision—Priority 8
         iv. Leadership names—Priority 3
         v. Organization Affiliation—Priority 2
         vi. When the organization was founded—Priority 7
         vii. Where the organization operates—Priority 4
         viii. Organization headquarters Location—Priority 5
      F. Groups indirectly Affected—Priority 6
         i. Type of Group—Priority 2
         ii. Mission—Priority 3
         iii. Leadership names—Priority 4
         iv. Group Affiliation—Priority 2
         v. When the group originated—Priority 6
         vi. Where the group originated—Priority 7
         vii. Where the group currently operates—Priority 3
         viii. Culture—Priority 4
         ix. Religions—Priority 4
   5. Sources of information—Priority 5
      A. Author Name
      B. Affiliation
      C. Date Published
   6. Individuals indirectly Involved—Priority 6
      A. Individual's details
         i. Names—Priority 1
         ii. Affiliation—Priority 3
         iii. Age—Priority 8
         iv. Residence—Priority 5
         v. Location—Priority 2
         vi. Origin—Priority 4
         vii. Experience—Priority 7
         viii. Titles—Priority 9
         ix. Public legal record—Priority 6
   7. Organizations indirectly involved—Priority 7
      A. Type of Organization—Priority 1
      B. Mission—Priority 2
      C. Vision—Priority 4
      D. Leadership names—Priority 3
      E. Organization Affiliation—Priority 5
      F. When the organization was founded—Priority 7
      G. Where the organization operates—Priority 6
      H. Organization headquarters Location—Priority 8
   8. Groups indirectly involved—Priority 8
      A. Type of Group—Priority 2
      B. Mission—Priority 1
      C. Leadership names—Priority 4
      D. Group Affiliation—Priority 2
      E. When the group originated—Priority 6
      F. Where the group originated—Priority 7
      G. Where the group currently operates—Priority 3
      H. Culture—Priority 5
      I. Religions—Priority 8
II. What—Priority 2
   1. Category of Event—Priority 1
   2. Secondary Category of Event—Priority 2
   3. Objects directly involved in the event—Priority 4
   4. Object Indirectly Involved—Priority 5
   5. Sentiment—Priority 3
      A. Polarity—Negative/nuetral/positive
      B. Confidence 0—100%
III. Where—Priority 3
   1. Locations of the event—Priority 1
      A. Where the event took place
   2. Direct Impact—Priority 2
      A. Areas affected directly
   3. Indirect Impact—Priority 3
      A. Areas Affected Indirectly
   4. Sources of information—Priority 4
      A. Links—Priority 5
      B. Book Titles—Priority 4
      C. Organizations—Priority 7
      D. Databases—Priority 2
      E. News Organizations—Priority 1
      F. Digital Magazines—Priority 6
      G. Social Media—Priority 3
IV. When—Priority 4
   1. When did the event happen—Priority 1
      A. Time
      B. Date
   2. When the source was published—Priority 2
      A. Time
      B. Date
   3. History of the Event—Priority 3
   4. Frequency of Event—Priority 4
      A. Time/date period
V. How—Priority 5
   1. How did the event happen—Priority 1
   2. Past events that directly lead to this particular event—Priority 3
   3. Conditions contributing to the event—Priority 4
   4. Possible motivations of those involved—Priority 2
   5. Techniques—Priority 5
   6. Methods—Priority 6
   7. Procedures—Priority 7
VI. Why—Priority 6
   1. Conditions required for the event to take place—Priority 1
   2. Direct Causes—Priority 2
   3. Indirect Causes—Priority 6
   4. Motivations—Priority 3
   5. Reasons—Priority 4
   6. Purpose—Priority 5

It is to be appreciated that although the above priority lists include particular categories and subcategories, any sort of categories, subcategories, and priority levels can be set by a user for any of a plurality of topics in accordance with aspects of the present invention.

An exemplary priority list for event analysis with decision making rules from block 304 can be customized for application in categorizing, setting priority, and weighting acquired data for particular types of reports/news articles (e.g., crime, business, entertainment, health, technology, travel, sports, opinion, etc.) and a report/article custom (or default) writing style can be customized by a user and/or default parameters can be utilized for generating reports/articles, in accordance with various embodiments of the present invention.

The following example is presented for illustrative purposes, and is representative of an exemplary report/news article (e.g., current news article, scientific paper, historical news article, etc.) for a predetermined (e.g., user-selected or default) report/news article tier based on data acquired from one or more of a plurality of data sources (e.g., news websites, police scanner, social media, blogs, etc.), in accordance with various aspects of the present invention.

For example, in an embodiment, an exemplary priority list, including a hierarchical set of priority rules (e.g., predetermined, learned, and/or user-specified), selectable search, data analysis, and report/news article generation options and parameters customizable by a user (e.g., Categories, Priorities, and Thresholds, Personality/Writing Style Parameter/Options Selection, Report/Article Boundaries/Threshold Levels, and or custom, user-specified parameters, priorities, thresholds, writing styles, etc.), for generating a customized report (e.g., news article) regarding “new governmental regulations” can be represented as follows:
1. Categories, Priorities and Thresholds
   I. Who—Priority 1—Report/Article Tier Length Content Threshold—20%
      1. Organizations directly involved—Priority 4
         A. Type of Organization—Priority 2
         B. Leadership names—Priority 3
         C. Where the organization operates—Priority 1
      2. Individuals directly Affected—Priority 2
         A. Individual's health/physical appearance details—Priority 9
         B. Names—Priority 1
         C. Affiliation—Priority 5
         D. Age—Priority 4
         E. Residence—Priority
         F. Location—Priority 2
         G. Origin—Priority 6
         H. Experience—Priority 7
         I. Titles—Priority 8
         J. Public legal record—Priority 3
      3. Organizations directly Affected—Priority 3
         A. Type of Organization—Priority 1
         B. Mission—Priority 8
         C. Vision—Priority 7
         D. Leadership names—Priority 6
         E. Organization Affiliation—Priority 3
         F. When the organization was founded—Priority 4
         G. Where the organization operates—Priority 2
         H. Organization headquarters Location—Priority 5
      4. Sources of information—Priority 1
         A. Author Name—Priority 1
         B. Affiliation—Priority 3
         C. Date Published—Priority 2
   II. What—Priority 3—Report/Article Tier Length Content Threshold—50%
      1. Category of Event—Priority 1 (Dictated by User)
      2. Secondary Category of Event—Priority 2
      3. Other Category—Priority 3
         A. Stated Topic
      4. Objects directly involved in the event—Priority 8
      5. Object Indirectly involved—Priority 7
      6. Actions directly involved—Priority 5
      7. Actions Indirectly involved—Priority 6
      8. Sentiment—Priority 4
         A. Polarity—Negative/neutral/positive
         B. Confidence Score—0-100%
   III. Where—Priority 2—Report/Article Tier Length Content Threshold—15%
      1. Locations of the event—Priority 2
         A. Where the event took place
      2. Direct Impact—Priority 3
         A. Areas affected Directly
      3. Indirect Impact—Priority 4
         A. Areas Affected Indirectly
      4. Sources of information—Priority 1
         A. Website—Priority 4
         B. Books—Priority 5
         C. Organizations—Priority 3
         D. Government—Priority 1
         E. Databases—Priority 7
         F. News Organizations—Priority 2
         i. International—Priority 1
         ii. National—Priority 2
         iii. Regional—Priority 3
         iv. Local—Priority 4
         v. Digital Magazines—Priority 5
         vi. Social Media—Priority 6
   IV. When—Priority 4—Report/Article Tier Length Content Threshold—5%
      1. When did the event happen—Priority 2
      2. Time span of the event—Priority 3
      3. Time the Event affects—Priority 1
      4. When the source was published—Priority 9
      5. History of the Event—Priority 8
      6. Frequency of Event—Priority 7
      7. Reporting Frequency—6
      8. Number of reports in the time span—Priority 5
      9. Predicted future impact of the event—Priority 4
   V. How—Priority 5—Report/Article Tier Length Content Threshold—30%
      1. How did the event happen—Priority 1
      2. Past events that directly lead to this particular event—Priority 3
      3. Conditions contributing to the event—Priority 4
      4. Possible motivations of those involved—Priority 2
      5. Techniques—Priority 5
      6. Methods—Priority 6
      7. Procedures—Priority 7
   VI. Why—Priority 6—Report/Article Tier Length Content Threshold—10%
      1. Conditions required for the event to take place—Priority 1
      2. Direct Causes—Priority 2
      3. Indirect Causes—Priority 6
      4. Motivations—Priority 3
      5. Reasons—Priority 4
      6. Purpose—Priority 5
2. Personality/Writing Style Parameter/Options Selection
   I. “Reporter A”
      1. Serious—90%
      2. Funny—10%
      3. Formal—75%
      4. Familiar—25%
   II. “Reporter B”
      1. Serious—90%
      2. Funny—50%
      3. Formal—30%
      4. Familiar—90%
3. Report/Article Boundaries/Threshold Levels
   I. Geographic Location
      1. Los Angeles Metro Area
   II. Report/Article Length
      1. 250 Words
   III. Keywords and Phrases
      1. Regulations
      2. Rules
      3. Laws
   IV. Event Date/Time Range
      1. Past 7 Days
      2. 7 am to 7 pm local event time

In some embodiments, in addition to the default ranking positions (e.g., Priority 1-10), the system can be trained at the NLG stage to adjust the priority of categories and subcategories depending on the source material (e.g., acquired data). For example, if the default setting has the individual rated at priority 1 but the source material overwhelmingly (e.g., greater than a user-selectable threshold amount (e.g., x % of acquired source material)) features an organization, then the priority level for the individual can be automatically changed (or changed upon notification and approval by a user) to a lower priority than the organization so that the report/news article is focused on what has been determined to be more important (e.g., organization more important than individual) based on the amount of source material (e.g., acquired data) for the selected topic. A user can also adjust the priority levels at any point during use of the present invention utilizing a GUI, and the threshold controls can be set as a percentage 0-100%, a particular number of data points acquired, number of sources utilized, etc., in accordance with aspects of the present invention.

For example, if the category is set at 0% for the individual then the system can be set by a user to change priority of the category only when it can't find any information on individuals directly involved at all, at 5% the priority can change when the system determines that the information in the category (or subcategory) falls below this particular threshold (e.g., 5% of the total information found), or any other percentage amount (or type of threshold condition) for any category and/or subcategory can be set by a user. Over time, using user input and generated reports/news articles, deep learning methods can be utilized for training and retraining a neural network to fine-tune the thresholds and priorities, and the system can gauge/adjust priorities in categories and subcategories more efficiently and more accurately corresponding to the priority levels for particular topics and/or report/news article types without any human in the loop interaction, in accordance with aspects of the present invention.

In various embodiments, in block 304, boundaries of the article in the priority list can be set by a user (e.g., to meet specific requests for reports/news articles from particular clients, to avoid (or increase) using data acquired from particular data sources, etc.), in accordance with aspects of the present invention. For example, a user can enter keywords for a search to return articles only from a particular source or sources (e.g., CNN, FOX News, etc.), particular categories of sources (e.g., national news, local news, etc.), or can enter negative keywords for the same to exclude the identified sources from a search. These keyword definitions and parameters can be set by a user and/or default definitions and parameters and keyword limit can be utilized, and a user can set a limit to an amount of keywords which can be utilized in a search to increase speed of the search and minimize processing power and/or network bandwidth requirements during execution, in accordance with aspects of the present invention.

As an example, for keywords “Washington Post, CNN, BBC, and MSNBC”, a user can set these data sources as having a highest priority for news gathering, and thus can be selected as initial sources for a selected category and/or topic of interest, and can exclude only data about an event from that source in a category that does not match the categories of interest. Negative keywords can be utilized to exclude particular sources, as although reports/news articles generally benefit from as many sources of data as possible, specific news sources that are known (or believed by a user) to be inaccurate can be excluded from a search. For example, negative keywords for data sources can include Breitbart, Babylon Bee, FOX News, etc., depending on parameters set by a user, and the sources related to these source keywords can be excluded from the sources utilized for the acquiring data. It is noted that although the keywords discussed above are illustratively depicted as data source keywords, it is to be appreciated that any sort of keywords can be utilized as keywords or negative keywords, in accordance with various aspects of the present invention.

In various embodiments, clustering can be utilized in block 306 for determining and acquiring relevant data for a particular report/news article. For example, as data/information is acquired in a first round (of a plurality of rounds) from any of a plurality of sources (e.g., news websites, social media, governmental news releases, etc.), “governments” can be selected as a first priority cluster for a given location, and the system can begin searching for data related to new events (e.g., in a selected time frame-1 day, 1 week, etc.). The NLP can identify relevant data posted in the selected time period, and then can search for relations in detail from successfully lower priority sources, as shown in the above priority list example. Relational information can be utilized to identify sources and gather information on all clusters as they are identified, in accordance with aspects of the present invention.

As an illustrative clustering example, it can be assumed that the U.S. federal government has posted a notice regarding new regulations regarding food safety in restaurants in a target area. It was stated as an update on the government RSS feed, the government's official website, has been reported on by several news outlets, and people have also been commenting on the new regulations on social media.

The category priorities from the above exemplary list can be utilized to seek out more information about the regulations until the thresholds on each question are met. Then that information can be sent to the NLG to generate a draft article with no word limit as a first draft. The draft can be sent back to the NLP to determine if a word count for each of a plurality of particular categories and/or subcategories is met, and if not, the system can search for more information in priority levels at each source level, and iteratively generating updated report/news article drafts until the word count is met. If the generated report/news article draft is determined to be above a selected word count level for the draft and/or categories or subcategories of the draft, NLP (e.g., NLU) can be utilized to determine relevancy of particular portions of the draft, and less relevant and/or less important information from the report/news article can be removed, and an updated draft can be iteratively generated until a word count threshold has been met, in accordance with aspects of the present invention.

In the above illustrative embodiment, the word count is a first priority for checking for completeness, but it is noted that any parameter and/or threshold can be utilized in any order, in accordance with aspects of the present invention. The NLP can be utilized to recheck the article to find high and/or low priority information in the acquired data to attempt to meet thresholds. If the article word count is met but not all other thresholds are not, the system can analyze the report/news article draft to locate and categorize information to determine an information and report quality (e.g., grammar, accuracy of content, etc.), and can perform edits to replace low-quality phrases or sentences, as determined to be low-quality using NLP techniques including model training and re-training, in order to meet a sufficient amount of thresholds, which can be set by a user, to generate a final report for publishing, in accordance with aspects of the present invention. In some embodiments,

In some embodiments, the system can catalog the sources of the information used, the sentimentality of the final article, and the thresholds met for each question in metadata, which can be utilized to train a neural network to better identify particular types of reports/news articles, sentimentality of the article, etc. for generating subsequent similar reports/news articles with increased speed and/or accuracy of content. Then the system can place the article and metadata in an editing queue to be checked and/or edited by a user, or by artificial intelligence editing, prior to storing and/or publishing the report/news article, in accordance with aspects of the present invention.

An example report/news article generated in a first round for the above “governmental” report example can be as follows:
Los Angeles County has recently implemented new food safety regulations intended to ensure the well-being of its citizens. Food-related businesses including restaurants, markets, and grocery stores must adhere to these laws in order to remain in operation.
The county has implemented several measures designed to protect public health, such as requiring establishments that serve food to display inspection ratings at their entrances and mandating regular inspections by qualified personnel. Food workers are also required to complete training courses on hygiene practices and proper food handling procedures.
Businesses found not in compliance with any of these regulations may be subject to fines or even closure. Food safety laws are there to help protect members of the community, and it is important that all establishments follow them.

The above example report/news article first draft can be checked to determine whether threshold conditions (e.g., word count) have been met using NLP techniques. In this illustrative example, the word count threshold from the above priority list is 250 (from the “Report/Article Length” subcategory), and the above example draft has only 125 words, so the word count threshold is not met. The report/news article and acquired data can then be analyzed using NLP techniques, and additional information can be added in iterative drafts until the threshold is met (or overridden by a user), in accordance with aspects of the present invention.

In block 308, a writing style can be selected and/or created for generation of a report/news article based on a default pre-trained artificial intelligence (AI) personality or a new AI personality created by the user. A report/news article can be generated in a style of one (or a combination of two or more) of the above-mentioned AI personalities based on the acquired data, one or more report/news article tier threshold levels (e.g., word count, percentage of content from different types of data sources, truth score threshold, etc.), prioritization and weighting, etc., as constraints for generating a report/news article in block 310.

In some embodiments, in block 312, a first report/article (e.g., news article, opinion article, scientific paper, etc.) based on the highest priority level data acquired, report/news article tier level, and other user-specified report/news article parameters using NLG techniques. In block 314, it can be determined whether the generated report/news article includes a threshold amount of information for the report/news article tier threshold level and report/news article parameters. If not all threshold conditions are satisfied, a next report/news article can be iteratively generated in block 316 based on a next highest priority level data acquired and user-specified report/news article parameters using NLG until the generated report/news article includes a threshold amount of information for the report/news article tier threshold level and report/news article parameters, in accordance with aspects of the present invention.

In some embodiments, one or more report/news article drafts can be iteratively generated by sequentially utilizing prioritized and/or categorized content from a highest priority level to a lowest priority level for the categories and/or subcategories until the one or more report threshold level constraints (e.g., user specified, learned using a neural network, default, etc.) are reached. In some embodiments, one or more report/news article drafts can be iteratively generated by sequentially utilizing prioritized and/or categorized content from a lowest priority level to a highest priority level for the categories and/or subcategories until the one or more report threshold level constraints (e.g., user specified, learned using a neural network, default, etc.) are reached, in accordance with aspects of the present invention.

In block 318, a quality score and/or an accuracy/truth score can be iteratively determined for the content of the generated report/news article and/or source data (e.g., by NLP techniques comparing against known accurate content, using a truth checker application (e.g., Google fact check), etc.), and content included in the report/news article determined to be below a threshold level (e.g., default or user specified) for accuracy/truth score can be identified, flagged, and/or removed from the generated report/news article.

In some embodiments, in block 318, a quality control engine can analyze the generated report (or any other documents) for quality of the report (e.g., sentence quality, relevance, etc.) based on any of a plurality of user-selected (or default) quality specifications using an extractive summarizer. For example, given a document D (e.g., generated report, acquired free-form documents, newspaper article, etc.) consisting of a sequence of sentences (e.g., s₁, S₂, . . . , Sₙ), a quality control engine including an extractive summarizer can be utilized to generate a summary S of the document by selecting a user-defined threshold number of sentences from D, where m<n. For each sentence sᵢ∈D, a label yᵢ∈{0,1} can be predicted (where 1 means that sᵢ is relevant and should be included in the summary for analysis) and a score p(yᵢ|sᵢ, D, θ) quantifying sᵢ's relevance to the summary. The model can utilize a neural network for training and/or retraining such that it learns to assign p(1|sᵢ, D, θ)>p (1|sⱼ, D, θ) when sentence sᵢ is more relevant than sⱼ. Model parameters are denoted by θ. The score p(yᵢ|sᵢ, D, θ) can be estimated using a neural network model and can assemble a summary of one or more documents S by selecting m sentences with a user-defined threshold level of top p(1|sᵢ, D, θ) scores. Components of the quality control engine can include a sentence encoder, a document encoder, and a sentence extractor, in accordance with aspects of the present invention.

In various embodiments, the quality control engine can generate a quality score for individual sentences (or other user-indicated selectable portions) in one or more documents, highlight and/or otherwise identify and categorize sentences (e.g., low quality, medium quality, high quality, etc.) into any of a plurality of user-creatable (or default) categories based on the quality score determined by the quality control engine, and can further provide recommendations for adjusting any sentences with quality control scores lower than a particular threshold number, in accordance with aspects of the present invention.

In block 320, a final report/news article determined to satisfy threshold conditions (e.g., using NLP, NLU and/or a neural network) can be generated (e.g., using NLG techniques), stored, and/or published, in accordance with aspects of the present invention. In block 322, the system 300 can utilize a neural network to iteratively optimize parameters over time (e.g., searching optimization, determining optimal word count for particular report/news article tiers, optimal writing style for particular story types, optimal number of sources for particular report/news article types, etc.) depending on story type, reader type, source type, trust score, etc., in accordance with aspects of the present invention. In block 324, a plurality of reports/articles (e.g., batch report/news article generation) can be automatically and/or iteratively generated for a plurality of topics based on pre-selected keywords and/or parameters (e.g., date range, place, person, etc.), in accordance with aspects of the present invention. In some embodiments, in block 324, one or more topics of interest (e.g., people, places, dates, etc.) can be determined as related and/or relevant to the presently generated report/news article by analyzing the presently generated report/news article using NLP techniques (e.g., NLU, keyword search, etc.), and presenting a selectable listing (e.g., buttons on a GUI, checkbox list, spreadsheet, etc.) of any of a plurality of topics of interest for selection of one or more of the topics for inclusion in a subsequent report/news article. In some embodiments, the selectable listing can be customized and/or filtered by a user based on any of a plurality of user-selectable (or default) filtering functions (e.g., sort by highest/lowest number of direct or indirect references to a particular topic of interest made in the presently generated report/news article, similar event occurring in a different geographic location, similar past events, etc.), in accordance with various aspects of the present invention.

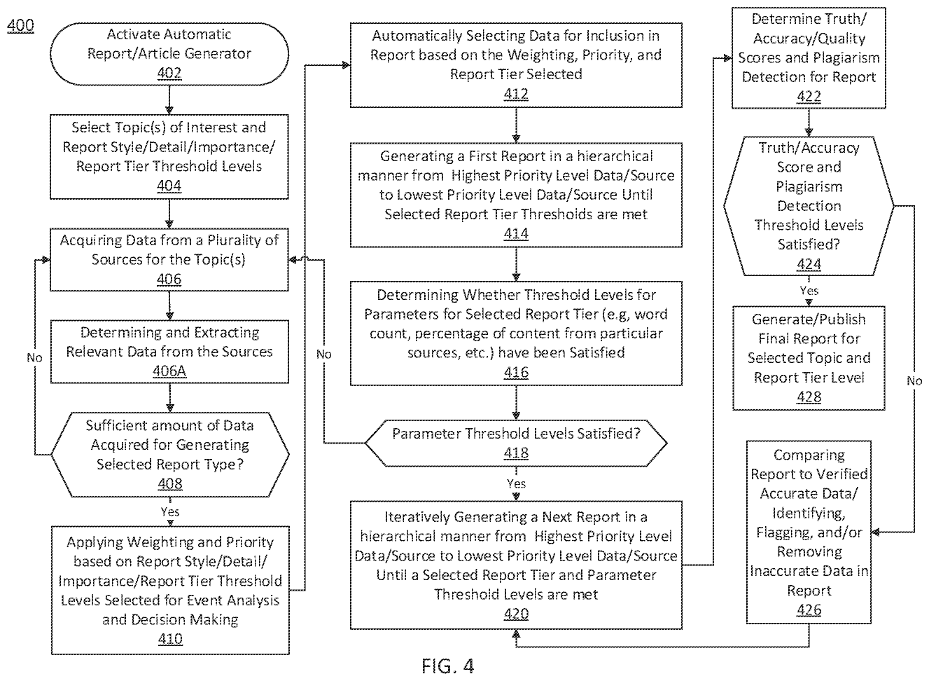

Referring now to FIG. 4, a block/flow diagram showing a method 400 for report/news article generation including acquiring, prioritizing, and weighting acquired data related to one or more topics of interest from a plurality of data sources, is illustratively depicted in accordance with an embodiment of the present invention.

In an embodiment, an automatic report/news article generator can be activated in block 402. In block 404, one or more topics of interest, report/news article style, detail level, importance levels (for story and/or content of story), report/news article tier thresholds, etc. can be selected for automated generation of a report/news article on the one or more topics of interest. Data can be acquired from a plurality of sources for the one or more topics of interest in block 406, and relevant data to the topics of interest can be determined and extracted from the acquired data in block 406A based on event analysis and decision making of the parameters, thresholds, report/news article levels selected. In block 408, it can be determined whether a sufficient amount of data (e.g., threshold level) has been acquired for generating a selected report/news article type. If no, additional data can be iteratively acquired in block 406 and relevant data can be determined and extracted in block 406 until a sufficient amount of data (e.g., threshold level) of data is determined to be acquired in block 408.

As described above, a sufficient amount of information in block 408 for particular categories and/or sub-categories can be defined by a user (or can be a default level), and can be based on quality of data acquired (e.g., truth score threshold satisfied) and/or a particular word count for particular categories and/or subcategories in a generated report/news article, in accordance with embodiments of the present invention. For example, a user can set a threshold percentage for each question answered (Who, What, Why, etc.), such as 50% of the “What” category and/or subcategory questions from a priority list (as shown above), and once the 50% threshold is reached, the system can iteratively determine sufficiency of information for other categories and/or subcategories until a 100% threshold level for all selected categories and/or subcategories is reached. In some embodiments, a user can indicate that sufficient information has been acquired prior to reaching a threshold using a computing device (e.g., computer, smartphone, tablet, etc.), in accordance with aspects of the present invention.

In block 410, weighting and priority can be applied to the acquired data based on report/news article style, detail, importance, tier threshold levels, etc. selected for event analysis and decision making. In block 412, data can be automatically selected for inclusion in a report/news article based on the weighting, priority, report/news article tier, etc. selected. In block 414, a first report/news article can be generated in a hierarchical manner from identified highest priority level data/data source to lowest priority level data/data source until selected report/news article tier thresholds are met.

In some embodiments, the priority takes precedence over the threshold. For example, If I want 100% of the “what” answered but the “who” is priority 1 and a user specifies that they want at least 50% of the “who” question answered, then the system will first generate text that answers the “who” question by 50% and then move on to attempt to answer the “what” question to 100%. For example, for a topic of a “lone gunman shoots an individual in downtown Los Angeles” with 100% of the “what” and 50% of the “who”, exemplary generated answers for these questions can include Los Angeles (100% of the “where” known) and the name of the gunman while the victim's name is unknown (50% of the “who” because only one of two involved people has been identified). If the system cannot find enough information to successfully complete a particular threshold, this can be notated in a user editing section, and can proceed to the next priority level, in accordance with aspects of the present invention.

In block 416, it can be determined whether threshold report/news article tier levels and parameter levels for a selected report/news article tier (e.g., word count, percentage of content from particular sources, percentage of questions (e.g., who, what, when, etc.), etc.) have been satisfied (e.g., using NLP, NLU, clustering, etc.). If parameters are determined to not be satisfied, additional data can be iteratively acquired in block 406, and steps 406A, 408, 410, 412, 414, and 416 can be iteratively repeated until parameter threshold levels are determined to have been satisfied in block 418. In accordance with various embodiments, a user can pre-define and or re-define priorities, thresholds, and other parameters before and/or during execution. This can include, for example, a user pre-defining and/or re-defining which data sources (e.g., Fox News, CNN, Facebook, NY Times, etc.), and/or types of data sources (e.g., national news, local news, police scanner, blog posts, scientific papers, social media, etc.) have higher or lower weights and priorities for generation of a report/news article, and it is noted that any priorities or weights can be customized by a user to generate a report/news article customized for style, content, and any other parameters and/or constraints, as specified by a user, in accordance with aspects of the present invention.

In various embodiments, if parameter threshold levels are determined to not be satisfied in block 418, a warming notification can be sent to a user device (e.g., smartphone, computer, tablet, etc.) identifying which particular categories and/or subcategories are not reaching required threshold levels (e.g., word count, insufficient data from trusted sources, etc.). In various embodiments, the user can either override such notifications and instruct the system to continue drafting the report/news article, add content by a manual human edit, and/or the system can be set for the drafting process to automatically iteratively proceed from block 406 by acquiring data from a plurality of sources for the selected topic or topics until a determination that parameter threshold levels are satisfied in block 418, in accordance with aspects of the present invention.

If parameter threshold levels are determined to be satisfied in block 418, a next report/news article for the selected topic or topics of interest can be generated in block 420 in a hierarchical manner based on the first report/news article and additional acquired data from a highest priority level data/data source identified highest priority level data/data source to lowest priority level data/data source for a selected report/news article tier and parameter thresholds, in accordance with various aspects of the present invention.

In block 422, truth, accuracy, and/or quality scores can be determined (e.g., by NLP techniques comparing against known accurate content, using a truth checker application (e.g., Google fact check), etc.), and plagiarism detection can be performed for the generated report/news article (e.g., by NLP techniques comparing the report/news article draft with acquired data using a threshold, Grammarly plagiarism detector, etc.) in accordance with aspects of the present invention. In block 424, it can be determined whether truth, accuracy, and/or quality scores and plagiarism detection threshold levels are satisfied for the generated report/news article, portions of the news article, and/or particular category and/or subcategory threshold levels. If no, the generated report/news article can be compared to verified accurate data from a plurality of local and/or remote sources and/or analyzed with a fact checker application, and identified inaccurate content can be flagged and/or automatically removed from the generated report/news article in block 426. A next report/news article draft can be iteratively generated in block 420 for additional truth/accuracy/quality score and plagiarism detection in block 422. If yes, a final report/news article can be generated, stored, and/or published for the selected topic of interest and report/news article tier level in block 428, in accordance with aspects of the present invention.

In various embodiments, in block 422, the system can evaluate and display a quality score for each piece of information acquired (e.g., relevant acquired data) based on information displayed and analyzed in clustered reports/articles. In some embodiments, there are no user-defined thresholds utilized for the determination of quality of the generated report/news article and/or the data acquired for generating the report/news article, but rather default threshold levels can be used for consistency in determining a quality score for any of a plurality of types of reports/news articles generated and/or received, to determine an accuracy of the data and/or report/news article, in accordance with aspects of the present invention.

An illustrative example of a quality score generated for one or more subcategories can be as follows. In this example, it can be assumed that information entities (e.g., answer to the category/subcategory questions) have been identified and matched to categories and/or subcategories. Once such information entities are identified and matched to categories and/or subcategories, they can be quantified and similar acquired information can be weighted against all compiled information (e.g., acquired data) as a percentage in block 422, described in further detail herein below.

Using an example of a “robbery” event, an exemplary quality determination can be as follows:
Event: Robbery
   Articles Found: 5
   Subcategory: Individual Directly Involved
   Second Subcategory: Name
   Article 1: Suspect: John Doe
   Article 2: Suspect: John Doe
   Article 3: Suspect: John Doe
   Article 4: Suspect: John Doe
   Article 5: Suspect: John Brian

In the above scenario, a result for the subcategories of “individual directly involved” and “name”, the result is an 80% accuracy score rating, as the search for data from five (5) data sources resulted in four (4) sources (e.g., local news, national news, blog posts, social media, etc.) returning the same name while a fifth (5^{th}) source returned a different (likely incorrect) name.

In an exemplary illustrative embodiment regarding the “who” from the priority list, accuracies of information found can be averaged together to determine a final overall accuracy ranking as follows:
Who: ((0.9+0.69)/2=0.795)=79.5% Overall Accuracy:
   Individual 1 Directly Involved:
      Suspect: ((0.9+0.75+0.080+0.40+0.60)/5=0.69)=69% Accuracy
         Name: 90% Accuracy
         Height: 75% Accuracy
         Weight: 80% Accuracy
         Race/Ethnicity: 40% Accuracy
         Relationship to Event: 60% Accuracy
   Individual 2 Directly Involved:
      Victim: ((0.9+0.9)/2=. 9)=90% Accuracy
         Name: 90% Accuracy
         Height: N/A (not reported)
         Weight: N/A (not reported)
         Race/Ethnicity: N/A (not reported)
         Relationship to Event: 90% Accuracy

In some embodiments, generated reports/news articles can be ranked according to how many thresholds have been reached for all categories of the priority list, and the ranking can include threshold data for individual categories and subcategories and/or an overall report/news article ranking using a weighted average based on priorities, in accordance with aspects of the present invention.

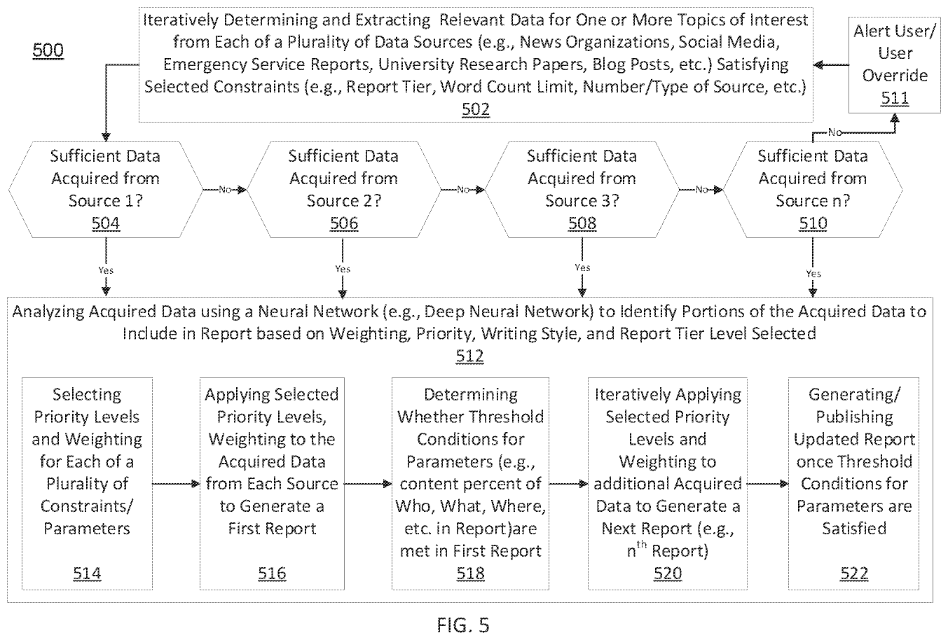

Referring now to FIG. 5, a block/flow diagram showing a method 500 for determining relevant data for inclusion in an automatically generated report/news article based on an analysis of acquired data related to one or more topics of interest from a plurality of data sources, is illustratively depicted in accordance with an embodiment of the present invention.

In various embodiments, relevant data for one or more topics of interest can be identified and/or acquired from one or more of a plurality of data sources (e.g., News Organizations, Social Media Sites, Emergency Service Reports, University Research Papers, Blog Posts, etc.) which satisfies selected constraints (e.g., report/news article tier, word count limit, number/type of sources, etc.) in block 502. It can be determined whether sufficient data has been acquired from a first data source (e.g., source 1) in block 504 based on word count for particular categories and/or subcategories from the first data source for a particular question (e.g., who, what, when, etc.), report/news article tier requirements, and any additional selected parameters and/or constraints specified by a user. If sufficient data is determined to not have been acquired from the first data source, it can be iteratively determined whether sufficient data has been acquired from the combination of data acquired from source 1 and source 2 in block 506, from sources 1, 2, and 3 in block 508, and from sources 1, 2, 3, . . . n in block 510, in accordance with aspects of the present invention.

If insufficient data has been determined to be acquired in block 510 after a threshold number of iterations, in block 511, a user can be notified of the deficiency and parameter adjustment recommendations can be presented to the user to enable additional data to be acquired and/or the user can override the determination of sufficiency of data acquired in block 504, 506, 508, and 510, and proceed to analyzing the acquired data in block 512. In block 511, the user can select, (e.g., using a GUI on a smartphone) to proceed with drafting a report/news article using the insufficient information acquired, adjust parameters and/or thresholds, add additional sources for data, add and/or remove categories and or subcategories, etc. upon notification that insufficient information has been acquired in block 510, in accordance with aspects of the present invention.

If sufficient data has been determined to be acquired in blocks 504, 506, 508, and/or 510, acquired data can be analyzed using a neural network (e.g., recurrent neural network (RNN), deep neural network (DNN), etc.) to identify portions of the acquired data relevant and appropriate for inclusion on a generated report/news article for the topics of interest based on weighting, priority, writing style, and/or report/news article tier level selected in block 512. Priority levels and weighting for each of a plurality of constraints and/or parameters can be selected in block 514, and selected priority levels and weighting can be applied to the acquired data from each of the plurality of sources to generate a first report/news article.

In block 518, it can be determined whether threshold conditions for parameters (e.g., content percent of Who, What, Where, Why, etc.) are met in the first report/news article draft. If not, additional data can be acquired and analyzed using natural language processing techniques and/or previously acquired data can be iteratively re-analyzed using natural language processing techniques. In some embodiments, selected priority levels and weighting can be iteratively adjusted and/or applied to additional acquired data (or for re-analyzing previously acquired data) to generate a next (e.g., updated from the first report/news article draft) report/news article draft (e.g., 2, 3, . . . n report/news article draft) in block 520 until all threshold conditions are met (or a user has overridden notifications that one or more threshold conditions have not been reached).

In various embodiments, in block 522, an updated finalized report/news article can be generated based on the iteratively generated and updated drafts from block 520, stored, and/or published once threshold conditions for parameters/constraints are determined to be satisfied. In some embodiments, the updated finalized report/news article generated in block 522 can be further analyzed for adherence to additional parameters, constraints, and/or thresholds, including for example, content accuracy (e.g., truth checker score), plagiarism detection, proper grammar use, adherence to a selected writing style/personality, etc., and a new, updated final report can be generated and analyzed based on the additional parameters, constraints, and/or thresholds, in accordance with aspects of the present invention.

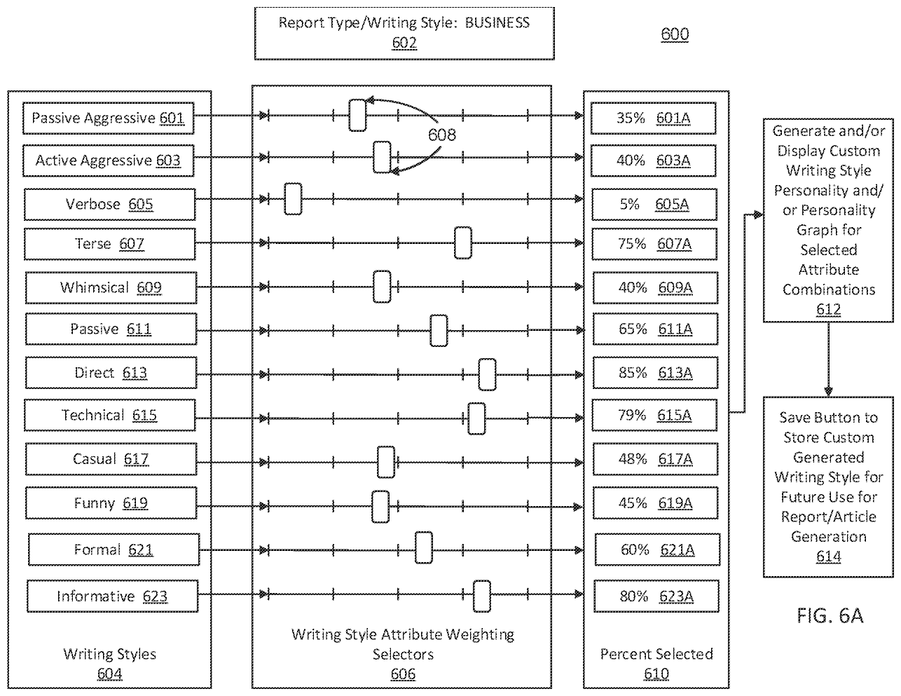

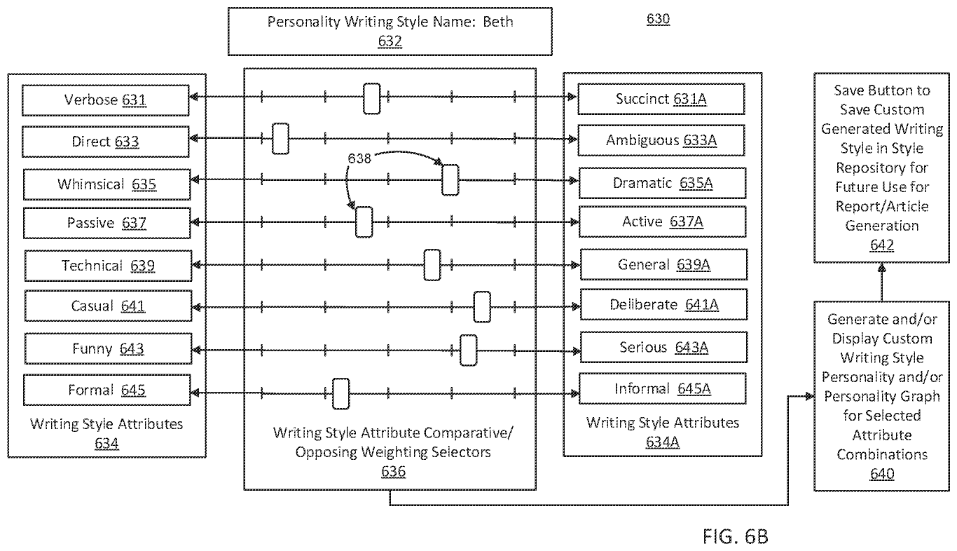

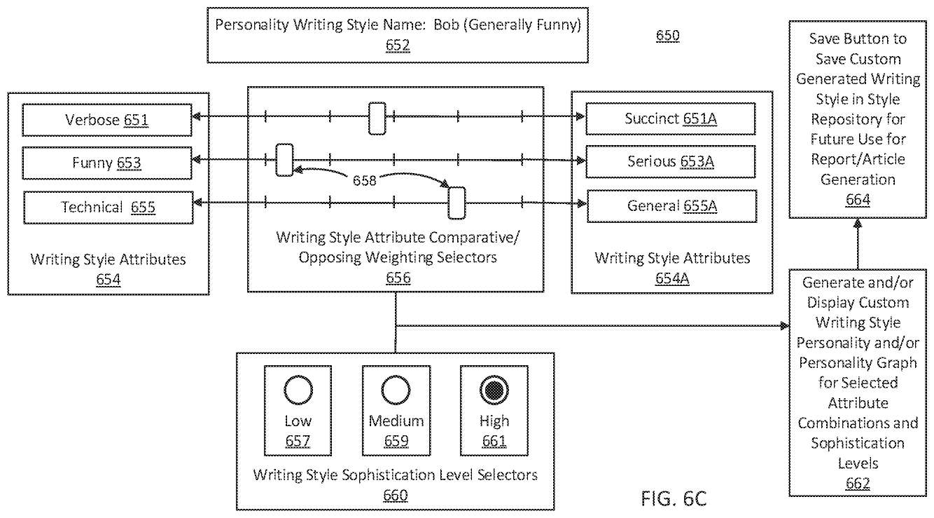

Referring now to FIG. 6A, a block/flow diagram showing a system and method 600 for creating and/or selecting a report/news article writing style for automatically generating a report/news article, is illustratively depicted in accordance with an embodiment of the present invention.

In some embodiments, a GUI can be configured for a user to select and/or create a writing style for the generated report/news article. Default report/news article writing styles (e.g., business, technical, comedic, informational, scientific, etc.) can be selected in block 602, and custom writing styles can be generated by combining attributes from different writing styles (e.g., passive aggressive 601, active aggressive 603, verbose 605, terse 607, whimsical 609, passive 611, direct 613, technical 615, casual 617, funny 619, formal 621, informative 623, etc.) from block 604 using writing style attribute weighting selectors in block 606 to select corresponding writing style percentages (e.g., 601A, 603A, 605A, 607A, 609A, 611A, 613A, 615A, 617A, 619A, 621A, 623A, respectively) for inclusion in a generated custom writing style/personality in block 610.

In various embodiments, developers can train the system in a set of default writing tones. In some embodiments, the user can create an AI writing personality/writing style by adjusting a series of sliders 606 that denotes percentage weights between two or more opposing attributes. These weights combined can make up the AI writer's personality/writing style. The training for each attribute can be conducted via API where developers will upload three or more pieces of content that reflect the desired attribute. In some embodiments, the connection of the pieces of content with the desired attribute can be finally judged by a human in the loop developers in addition to being judged and updating using NLP techniques, including for example, NLU, when generating a customized writing style/personality.

In some embodiments, a NLG can be trained with samples that denote the desired attributes across the personality spectrum (e.g., Happy, Funny, Verbose, Aggressive, etc.), and different attributes can be identified and categorized (e.g., by a user or by NLP techniques including NLU) to generate different writing style personalities for selection when drafting reports/news articles. The NLG can generate works using a probability percentage of any given personality attribute from a plurality of potential personality attributes based on the training samples. Data can be acquired for training for any of a plurality of personalities by collecting a corpus of data representing, for example “Funny” from 0%-100%, a zero score in this category would be applicable to be selected for generation of a news article covering a violent crime event, while a 100% score would be applicable for a transcript of a funny stand-up comedian's performance, in accordance with aspects of the present invention.

In various embodiments, the customized writing style/personality can be stored and/or selected by one or more users for drafting a report/news article in the generated writing style/personality. New attributes can be added by the user by the user, and can include naming the writing tone attribute and uploading at least three pieces of content that reflect that attribute, and can be utilized as training data for a neural network for use in generating additional writing styles, categorizing of attributes, etc., in accordance with aspects of the present invention. Such content can be further utilized by an iteratively trained neural network to generate and fine-tune the writing styles/personalities, attributes, categories, etc. generated to optimize accuracy and speed of generation of one or more writing styles/personalities during use. It is noted that at least in part due to the weighting/prioritizing system described above, an opposing attribute can be utilized to create a scale between the two attributes (e.g., three pieces of content), in accordance with aspects of the present invention.

A writing style/personality graph can be generated and/or displayed in block 612, and the custom generated writing style/personality can be stored locally or remotely for future use for report/news article generation in block 614, in accordance with various aspects of the present invention. In various embodiments, the writing style attribute weighting selectors 606 can be utilized to provide a writing style and/or direction for a report/news article for drafting a report/news article. Some conventional NLP models can include a default set of writing styles in which to generate text for display to a user, but conventional systems do not provide any means to customize writing styles by an end user. The present invention can include a default writing style/personality set, and the end user can adjust the weighting using the selectors 606 to generate new, weighted writing styles/personalities for utilization in drafting a report/news article according to the generated, customized writing style/personality, in accordance with aspects of the present invention.

In various embodiments, each new writing style/personality generated using the selectors 606 can utilize a set of attributes from which to draw upon styles (e.g., passive aggressive 601, active aggressive 603, verbose 605, terse 607, whimsical 609, passive 611, direct 613, technical 615, casual 617, funny 619, formal 621, informative 623, etc.) from block 604 using writing style attribute weighting selectors in block 606 to select corresponding writing style percentages (e.g., 601A, 603A, 605A, 607A, 609A, 611A, 613A, 615A, 617A, 619A, 621A, 623A, respectively) for inclusion in a generated custom writing style/personality in block 610. Each of these attributes can have weights assigned to them between 0 and 100%, selectable using the selectors 606 (e.g., sliders, checkboxes, selectable option buttons, etc.). The weight can correspond to how much of that attribute will be prioritized in the NLG's word choice and sentence structure for the overall writing style/personality selected, and a user can create one or more new writing styles/personalities by selecting different percentage weights from the series of sliders (e.g., selectors 606) and saving the new writing style/personality with a unique name for future use, in accordance with aspects of the present invention.

In an exemplary illustrative embodiment, a writing style/personality for use in drafting an original report/news article written in a custom generated writing style/personality can be generated by positioning sliders, and can generate a report/news article in the custom generated writing style using a multinomial distribution to calculate a probability of which particular writing style/personality a next phrase, word, paragraph, etc., will be in a particular portion (e.g., sentence, paragraph, selected area, etc.) or a document as follows:

$$P = \frac{n !}{( {n}_{1} ! ) ( {n}_{2} ! ) … ( {n}_{x} ! )} ( ( {P}_{{1}^{n 1}} ) ( {P}_{{2}^{n 2}} ) … ( {P}_{{x}^{n x}} ) )$$

Where P represents an overall probability of a selection of a particular writing style for a next portion of a document (e.g., word, sentence, paragraph, etc.), n represents a number of events, n₁ represents a number of outcomes for event 1, n₂ represents a number of outcomes for event 2, nₓ represents a number of outcomes for event x, p₁ represents a probability that event 1 occurs, p₂ represents a probability that event 2 occurs, and pₓ represents a probability that event x occurs, in accordance with aspects of the present invention.

In various embodiments, the above equation can be applied at the word, phrase, paragraph, and document levels (e.g., the “n” can be representative of a phrase, sentence, paragraph, document, etc., in accordance with aspects of the present invention. The NLG can iterate until the probabilities match a desired selectable outcome (e.g., reach a user-specified threshold level for any of a plurality of attributes and/or constraints). The system can be pre-trained and/or iteratively retrained during execution, using NLP techniques and a neural network, to establish relationships that determine, in real time during generation of a report and/or after report generation, whether a word, phrase, sentence, paragraph, document, etc., is drafted in the selected writing style (e.g., serious or funny, verbose or succinct, etc.) to an appropriate weighted amount (e.g., 80% serious for a non-violent crime report/news article). The writing style/personality selected can be utilized in conjunction with an NLG to assist in selecting particular words or phrases during report generation. In some embodiments, a notification (e.g., alarm, popup, etc.) on a GUI can alert a user to any portions of a generated report/news article which do not meet any particular thresholds (e.g., outliers) and/or provide selectable suggestions and/or override options for a user regarding the identified outliers, in accordance with aspects of the present invention.

Referring now to FIG. 6B, a block/flow diagram showing a system and method 630 for creating and/or selecting a report/news article writing style for automatically generating a report/news article, is illustratively depicted in accordance with an embodiment of the present invention.

In some embodiments, a GUI can be configured for a user to select and/or create a writing style for the generated report/news article. Default report/news article writing styles (e.g., business, technical, comedic, informational, scientific, etc.) can be selected in block 602, and the selectors/sliders 630 in the writing style attribute comparative/opposing weighting selector GUI 638 can be automatically adjusted to display the sliders 638 representative of particular attributes for a particular writing style upon selection of that particular default writing style. In some embodiments, a user can utilize the sliders to generate custom writing styles by combining attributes from any of a plurality of selectable opposing writing style attributes (e.g., verbose 631, succinct 631A; direct 633, ambiguous 633A; whimsical 635, dramatic 635A; passive 637, active 637A; technical 639, general 639A; casual 641, deliberate 641A; funny 643, serious 643A; formal 645, informal 645A, etc.) from blocks 634 and 634A, respectively, using writing style attribute weighting selectors 638 in block 636 to select corresponding comparative writing style attribute percentages for inclusion in a generated custom writing style/personality in block 640 in accordance with aspects of the present invention.

In various embodiments, developers can train the system in a set of default writing tones. In some embodiments, the user can create an AI writing personality/writing style by adjusting a series of sliders 636 that denotes percentage weights between two or more opposing attributes. These weights combined can make up the AI writer's personality/writing style. The training for each attribute can be conducted via API where developers will upload three or more pieces of content that reflect the desired attribute. In some embodiments, the connection of the pieces of content with the desired attribute can be finally judged by a human in the loop developers in addition to being judged and updating using NLP techniques, including for example, NLU, when generating a customized writing style/personality.

In some embodiments, a NLG can be trained with samples that denote the desired attributes across the personality spectrum (e.g., Happy, Funny, Verbose, Aggressive, etc.), and different attributes can be identified and categorized (e.g., by a user or by NLP techniques including NLU) to generate different writing style personalities for selection when drafting reports/news articles. The NLG can generate works using a probability percentage of any given personality attribute from a plurality of potential personality attributes based on the training samples. Data can be acquired for training for any of a plurality of personalities by collecting a corpus of data representing, for example “Funny” from 0%-100%, a zero score in this category would be applicable to be selected for generation of a news article covering a violent crime event, while a 100% score would be applicable for a transcript of a funny stand-up comedian's performance, in accordance with aspects of the present invention.

In various embodiments, the customized writing style/personality can be stored and/or selected by one or more users for drafting a report/news article in the generated writing style/personality. New attributes can be added by the user by the user, and can include naming the writing tone attribute and uploading at least three pieces of content that reflect that attribute, and can be utilized as training data for a neural network for use in generating additional writing styles, categorizing of attributes, etc., in accordance with aspects of the present invention. Such content can be further utilized by an iteratively trained neural network to generate and fine-tune the writing styles/personalities, attributes, categories, etc. generated to optimize accuracy and speed of generation of one or more writing styles/personalities during use. It is noted that at least in part due to the weighting/prioritizing system described above, an opposing attribute can be utilized to create a scale between the two attributes (e.g., three pieces of content), in accordance with aspects of the present invention.

A writing style personality and/or writing style/personality graph can be generated and/or displayed in block 640, and the custom generated writing style/personality can be stored locally or remotely for future use for report/news article generation in block 642, in accordance with various aspects of the present invention. In various embodiments, the writing style attribute weighting selectors 636 can be utilized to provide a writing style and/or direction for a report/news article for drafting a report/news article. Some conventional NLP models can include a default set of writing styles in which to generate text for display to a user, but conventional systems do not provide any means to customize writing styles by an end user. The present invention can include a default writing style/personality set, and the end user can adjust the weighting using the selectors 638 to generate new, weighted writing styles/personalities for utilization in drafting a report/news article according to the generated, customized writing style/personality, in accordance with aspects of the present invention.

In various embodiments, each new writing style/personality generated using the selectors 638 can utilize a set of attributes from which to draw upon styles (e.g., verbose 631, succinct 631A; direct 633, ambiguous 633A; whimsical 635, dramatic 635A; passive 637, active 637A; technical 639, general 639A; casual 641, deliberate 641A; funny 643, serious 643A; formal 645, informal 645A, etc.) from blocks 634 and 634A, respectively, using writing style attribute weighting selectors 638 in block 636 to select corresponding opposing writing style attribute percentages (e.g., selecting 45% verbose in block 631 automatically would include 55% as succinct from block 631A) for inclusion in a generated custom writing style/personality in block 640. Each of these attributes can have weights assigned to them between 0 and 100%, selectable using the selectors 638 in block 636. The weight can correspond to how much of that attribute will be prioritized in the NLG's word choice and sentence structure for the overall writing style/personality selected, and a user can create one or more new writing styles/personalities by selecting different percentage weights from the series of selectors/sliders 638, and saving the new writing style/personality with a unique name for future use, in accordance with aspects of the present invention.

Referring now to FIG. 6C, a block/flow diagram showing a system and method 650 for creating and/or selecting a report/news article writing style for automatically generating a report/news article, is illustratively depicted in accordance with an embodiment of the present invention.

In some embodiments, a GUI can be configured for a user to select and/or create a writing style for the generated report/news article. Default report/news article writing styles (e.g., business, technical, comedic, informational, scientific, etc.) and/or a customized personality writing style name (e.g., Bob) can be selected in block 652, and the selectors/sliders 658 in the writing style attribute comparative/opposing weighting selector GUI 656 can be automatically adjusted to display the sliders 658 representative of particular attributes for a particular writing style upon selection of that particular default writing style. In some embodiments, a user can utilize the sliders to generate custom writing styles by combining attributes from any of a plurality of selectable opposing writing style attributes (e.g., verbose 651, succinct 651A; funny 653, serious 653A; technical 655, general 655A, etc.) from blocks 654 and 654A, respectively, using writing style attribute weighting selectors 658 in block 656 to select corresponding comparative writing style attribute percentages for combination with a selected writing style sophistication selectors (e.g., low 657, medium 659, high, 661, etc.) for inclusion in a generated custom writing style/personality in block 662 in accordance with aspects of the present invention.

In various embodiments, the selections from the writing style attribute comparative/opposing weighting selectors from block 656 can be utilized in conjunction with the writing style sophistication level selectors 657, 659, 661 to generate a report/news article tailored for a particular sophistication (e.g., education level, intelligence level, etc.) by adjusting a sophistication level (e.g., education level (e.g., elementary school, high school, college levels corresponding to low, medium, and high selections), difficulty level of understanding of a particular topic (e.g., low, medium, high, etc.) using the sophistication level selectors 657, 659, 661, in accordance with aspects of the present invention. Thresholds for thee sophistication levels can be pre-trained with default settings and/or or iteratively retrained to optimize the sophistication level categorization of acquired data during generation of a report/news article, in accordance with aspects of the present invention.

In various embodiments, developers can train the system in a set of default writing tones. In some embodiments, the user can create an AI writing personality/writing style by adjusting a series of sliders 658 in block 656 that denotes percentage (or other quantifiable amount—e.g., scale of 1-5, yes or no selector for inclusion, etc.) between two or more opposing attributes. These combined weights, in addition to the writing style sophistication level selectors 660 can be utilized to generate the AI writer's personality/writing style in block 662. The training for each attribute can be conducted via API, using a brute force algorithm in which a plurality of pieces of content (e.g., three or more pieces of content) that reflect the desired attribute. In some embodiments, the connection of the pieces of content with the desired attribute can be finally judged by a human in the loop developers in addition to being judged and updating using NLP techniques, including for example, NLU, when generating a customized writing style/personality.

In some embodiments, an NLG can be trained with samples that denote the desired attributes across the personality spectrum (e.g., Happy, Funny, Verbose, Aggressive, etc.), and different attributes can be identified and categorized (e.g., by a user or by NLP techniques including NLU) to generate different writing style personalities for selection when drafting reports/news articles. The NLG can generate reports/news articles using a probability percentage of any given personality attribute from a plurality of potential personality attributes based on the training samples. Data can be acquired for training for any of a plurality of personalities by collecting a corpus of data representing, for example “Funny” from 0%-100%, a zero score in this category would be applicable to be selected for generation of a news article covering a violent crime event, while a 100% score would be applicable for a transcript of a funny stand-up comedian's performance, in accordance with aspects of the present invention.

In some embodiments, a writing style can be generated based on a brute-force type algorithm iterating through all potential combinations of writing style attributes 654, 654A and weight amounts selected in block 656, and combining the result from block 656 with a pre-trained (or iteratively trained using a neural network and optimization during use) sophistication level from block 660, in accordance with aspects of the present invention. For example, when generating a personality writing style 652, a brute-force algorithm can be utilized by including a predetermined (e.g., user specified, developer specified, etc.) number of attribute sliders 658 which do not contradict or overlap with regard to the attributes selectable for sliders 658 to generate a writing style for each potential combination of selected attributes 651. 651A, 653, 653A, 655, 655A. For example, attribute Technical 655 can be included as an opposing attribute for general 655A. However, if a user attempted to add additional opposing sliders for attributes determined to be similar, related, or contradictory to already selected attributes, (e.g., scientific vs. ambiguous), an alert and/or suggestions for resolving a potential conflict can be sent to a user (e.g., GUI on a personal computing device) and/or the generation of the personality writing style for block 662 can be halted until a user either resolves the issue or overrides the alert, in accordance with aspects of the present invention.

In various embodiments, the customized writing style/personality can be stored and/or selected by one or more users for drafting a report/news article in the generated writing style/personality in block 664. New attributes can be added by the user by the user, and can include naming the writing tone attribute and uploading at least three pieces of content that reflect that attribute, and can be utilized as training data for a neural network for use in generating additional writing styles, categorizing of attributes, etc., in accordance with aspects of the present invention. Such content can be further utilized by an iteratively trained neural network to generate and fine-tune the writing styles/personalities, attributes, categories, etc. generated to optimize accuracy and speed of generation of one or more writing styles/personalities during use. It is noted that at least in part due to the weighting/prioritizing system described above, an opposing attribute can be utilized to create a scale between the two attributes (e.g., three pieces of content), in accordance with aspects of the present invention.

A writing style personality and/or writing style/personality graph can be generated and/or displayed in block 662, and the custom generated writing style/personality can be stored locally or remotely for future use for report/news article generation in block 664, in accordance with various aspects of the present invention. In various embodiments, the writing style attribute weighting selectors 656 can be utilized to provide a writing style and/or direction for a report/news article for drafting a report/news article. Some conventional NLP models can include a default set of writing styles in which to generate text for display to a user, but conventional systems do not provide any means to customize writing styles by an end user. The present invention can include a default writing style/personality set, and the end user can adjust the weighting using the selectors 658, in combination with the writing style sophistication level selectors 660, to generate new, weighted writing styles/personalities for utilization in drafting a report/news article according to the generated, customized writing style/personality, in accordance with aspects of the present invention.

In various embodiments, each new writing style/personality generated using the selectors 638 can utilize a set of attributes from which to draw upon styles (e.g., verbose 651, succinct 651A; funny 653, serious 653A, technical 655, general 655A, etc.) from blocks 654 and 654A, respectively, using writing style attribute weighting selectors 658 in block 656 to select corresponding opposing writing style attribute percentages (e.g., selecting 45% verbose in block 631 automatically would include 55% as succinct from block 651A) for inclusion in a generated custom writing style/personality in block 662. Each of these attributes can have weights assigned to them between 0 and 100%, selectable using the selectors 658 in block 656. The weight can correspond to how much of that attribute will be prioritized in the NLG's word choice and sentence structure for the overall writing style/personality selected, and a user can create one or more new writing styles/personalities by selecting different percentage weights from the series of selectors/sliders 658, combining with a selected writing style sophistication level selectors in block 660, and saving the new writing style/personality with a unique name for future use in block 664, in accordance with aspects of the present invention.

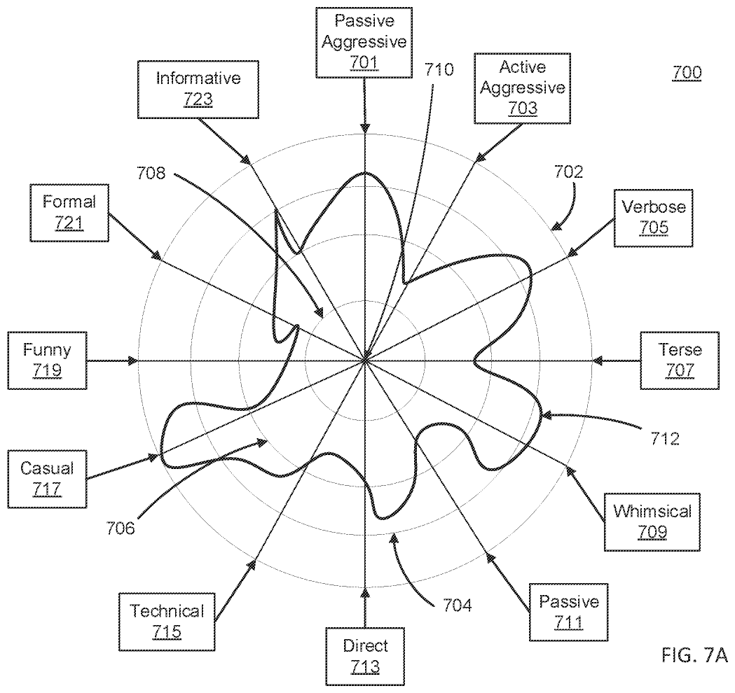

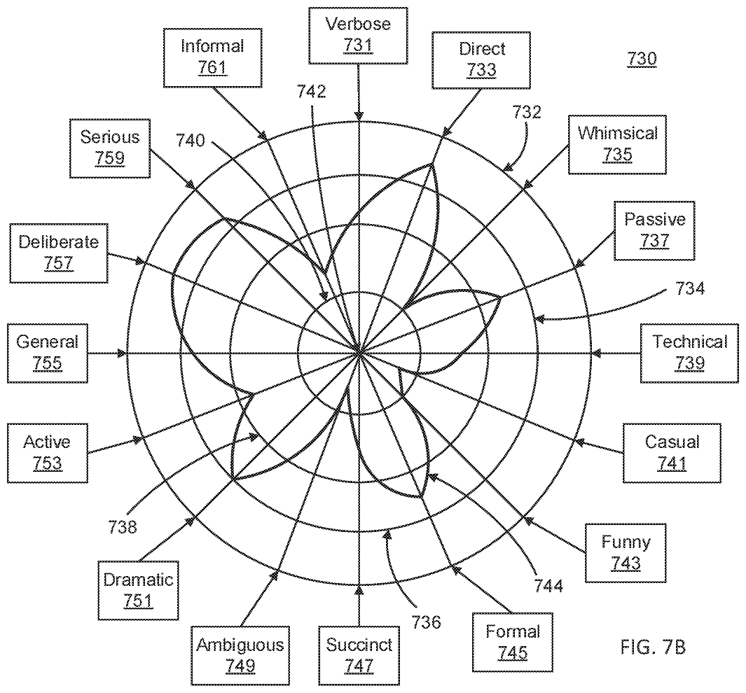

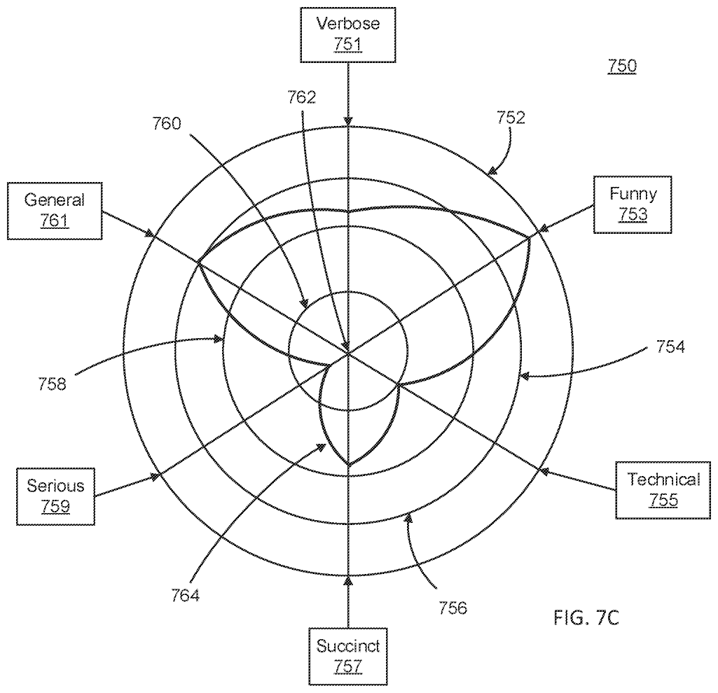

Referring now to FIG. 7A, with continued reference to FIG. 6A, a diagram showing an exemplary personality graph 700 for creating and/or selecting a report/news article writing style for generating a report/news article based on the selected sliders/selectors 608 of FIG. 6A, is illustratively depicted in accordance with an embodiment of the present invention.

In various embodiments, elements 702, 704, 706, 708, and 710 can represent labels for writing style percentages of 100%, 75%, 50%, 25%, and 0%, respectively, for utilization in generating a writing/personality style. In this exemplary personality graph 700, the parent writing styles for which percentages can be included are passive aggressive 701, active aggressive 703, verbose 705, terse 707, whimsical 709, passive 711, direct 713, technical 715, casual 717, funny 719, formal 721, and informative 723, and are plotted along a curve 712. However, it is to be appreciated that any sort of parent writing styles can be generated, learned, and optimized by training and utilizing a neural network and/or using NLP techniques, in accordance with aspects of the present invention.

Referring now to FIG. 7B, with continued reference to FIG. 6B, a diagram showing an exemplary personality graph 730 for creating and/or selecting a report/news article writing style for generating a report/news article based on the selected sliders/selectors 638 of FIG. 6B, is illustratively depicted in accordance with an embodiment of the present invention.

In various embodiments, elements 732, 734, 736, 738, and 740 can represent labels for writing style percentages of 100%, 75%, 50%, 25%, and 0%, respectively, for utilization in generating a writing/personality style. In this exemplary personality graph 730, the parent writing styles for which percentages can be included are verbose 731, direct 733, whimsical 735, passive 737, technical 739, casual 741, funny 743, formal 745, succinct 747, ambiguous 749, dramatic 751, active 753, general 755, deliberate 757, serious 759, and informal 761, and are plotted along a curve 744. However, it is to be appreciated that any sort of parent writing styles can be generated, learned, and/or optimized by training and utilizing a neural network and/or using NLP techniques, in accordance with aspects of the present invention.

Referring now to FIG. 7C, with continued reference to FIG. 6C, a diagram showing an exemplary personality graph 750 for creating and/or selecting a report/news article writing style for generating a report/news article based on the selected sliders/selectors 658, 657, 659, 661 of FIG. 6C, is illustratively depicted in accordance with an embodiment of the present invention.

In various embodiments, elements 752, 754, 756, 758, and 760 can represent labels for writing style percentages of 100%, 75%, 50%, 25%, and 0%, respectively, for utilization in generating a writing/personality style. In this exemplary personality graph 750, the parent writing styles for which percentages can be included are verbose 751, funny 753, technical 755, succinct 757, serious 759, and general 761, and are plotted along a curve 764. However, it is to be appreciated that any sort of parent writing styles can be generated, learned, and/or optimized by training and utilizing a neural network and/or using NLP techniques, in accordance with aspects of the present invention.

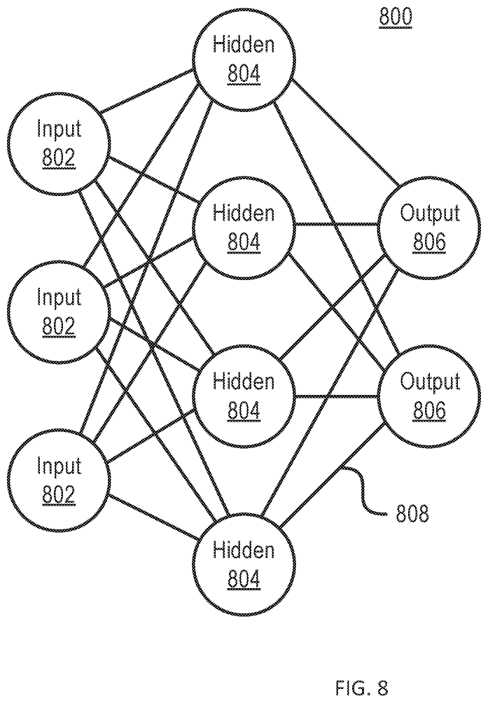

Referring now to FIG. 8, a generalized diagram showing an exemplary neural network 800 for artificial intelligence-based data analysis, automated report/news article generation, and optimization, is illustratively depicted in accordance with an embodiment of the present invention.

An artificial neural network (ANN) is an information processing system that is inspired by biological nervous systems, such as the brain. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 802 that provide information to one or more “hidden” neurons 804. Connections 808 between the input neurons 802 and hidden neurons 804 are weighted, and these weighted inputs are then processed by the hidden neurons 804 according to some function in the hidden neurons 804. There can be any number of layers of hidden neurons 804, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 806 accepts and processes weighted input from the last set of hidden neurons 804.

This represents a “feed-forward” computation, where information propagates from input neurons 802 to the output neurons 806. Upon completion of a feed-forward computation, the output is compared to a desired output available from training data. The error relative to the training data is then processed in “backpropagation” computation, where the hidden neurons 804 and input neurons 802 receive information regarding the error propagating backward from the output neurons 806. Once the backward error propagation has been completed, weight updates are performed, with the weighted connections 808 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 808 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 808 (e.g., priority list weights, attribute weights for generating writing style/personalities, etc.) may be implemented as resistive processing units (RPUs), generating a predictable current output when an input voltage is applied in accordance with a settable resistance.

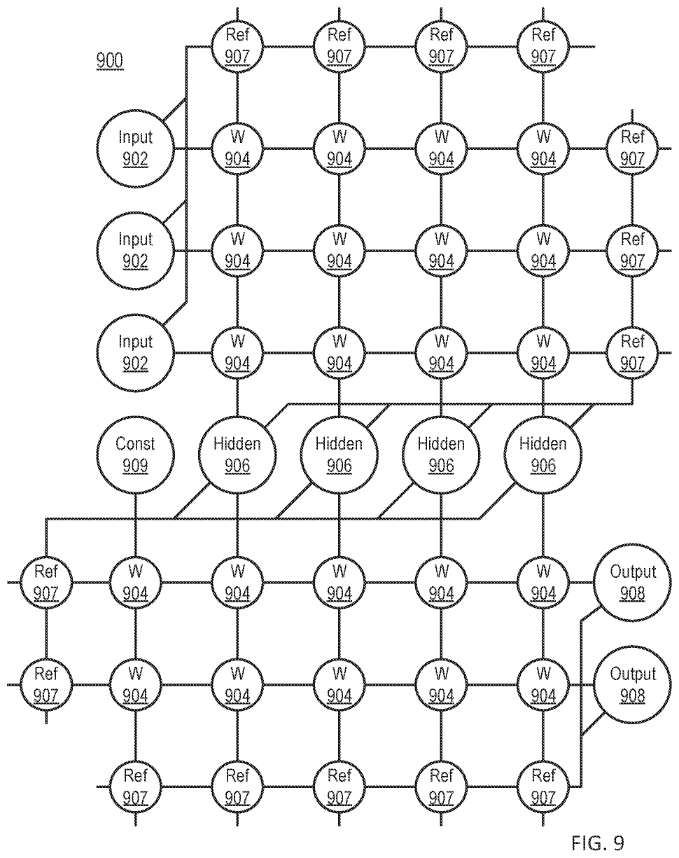

Referring now to FIG. 9, a hardware diagram showing an exemplary artificial neural network (ANN) 900 for artificial intelligence-based data analysis, automated report/news article generation, and optimization, is illustratively depicted in accordance with an embodiment of the present invention.

It should be understood that the present architecture is purely exemplary, and that other architectures or types of neural network can be used instead. The hardware embodiment described herein is included with the intent of illustrating general principles of neural network computation at a high level of generality and should not be construed as limiting in any way.

Furthermore, the layers of neurons described below and the weights connecting them are described in a general manner and can be replaced by any type of neural network layers with any appropriate degree or type of interconnectivity. For example, layers can include convolutional layers, pooling layers, fully connected layers, softmax layers, or any other appropriate type of neural network layer. Furthermore, layers can be added or removed as needed, and the weights described herein can be replaced with more complicated forms of interconnection.

During feed-forward operation, input neurons 902 each provide an input voltage in parallel to a respective row of weights 904. In the hardware embodiment described herein, the weights 904 each have a settable resistance value, such that a current output flows from the weight 904 to a respective hidden neuron 906. The current output by the weight 904 therefore represents a weighted input to the hidden neuron 906.

Following the hardware embodiment, the current output by a given weight 904 is determined as

$$I = \frac{V}{r} ,$$

where V is the input voltage from the input neuron 902 and r is the set resistance of the weight 904. The currents from each of the weights 904 (e.g., priority list weights, attribute weights for generating writing style/personalities, etc.) add column-wise and flow to a hidden neuron 906.

A set of reference weights 907 have a fixed resistance and combine their outputs into a reference current that is provided to each of the hidden neurons 906. Because conductance values can only be positive numbers, some reference conductance is needed to encode both positive and negative values in the matrix. The currents produced by the weights 904 are continuously valued and positive, and therefore the reference weights 907 are used to provide a reference current, above which currents are considered to have positive values and below which currents are considered to have negative values. The use of reference weights 907 is not needed in software embodiments, where the values of outputs and weights can be precisely and directly obtained. As an alternative to using the reference weights 907, another embodiment can use separate arrays of weights 904 to capture negative values.

The hidden neurons 906 use the currents from the array of weights 904 and the reference weights 907 to perform some calculation. This calculation may be, for example, any appropriate activation function, and may be implemented in hardware using appropriate circuitry, or in software.

The hidden neurons 906 then output a voltage of their own, based on the activation function, to another array of weights 904. This array performs its weighting calculations in the same way, with a column of weights 904 receiving a voltage from their respective hidden neuron 906 to produce a weighted current output that adds row-wise and is provided to the output neuron 908.

It should be understood that any number of these stages can be implemented, by interposing additional layers of arrays and hidden neurons 906. It should also be noted that some neurons can be constant neurons 909, which provide a constant output to the array. The constant neurons 909 can be present among the input neurons 902 and/or hidden neurons 906 and are only used during feed-forward operation.

During back propagation, the output neurons 908 provide a voltage back across the array of weights 904. The output layer compares the generated network response to training data and computes an error. The error is applied to the array as a voltage pulse, where the height and/or duration of the pulse is modulated proportional to the error value. In this example, a row of weights 904 receives a voltage from a respective output neuron 908 in parallel and converts that voltage into a current which adds column-wise to provide an input to hidden neurons 906. The hidden neurons 906 combine the weighted feedback signal with a derivative of its feed-forward calculation and stores an error value before outputting a feedback signal voltage to its respective column of weights 904. This back propagation travels through the entire network 900 until all hidden neurons 906 and the input neurons 902 have stored an error value.

The weight update process will depend on how the weights 904 are implemented. For settable resistances that include phase change materials, the input neurons 902 and hidden neurons 906 may apply a first weight update voltage forward and the output neurons 908 and hidden neurons 906 may apply a second weight update voltage backward through the network 900. The combinations of these voltages may create a state change within each weight 904, causing the weight 904 to take on a new resistance value, for example by raising a temperature of the weight 904 above a threshold and thus changing its resistance. In this manner the weights 904 can be trained to adapt the neural network 900 to errors in its processing.

As noted above, the weights 904 can be implemented in software or in hardware, for example using relatively complicated weighting circuitry or using resistive cross point devices. Such resistive devices may have switching characteristics that have a non-linearity that can be used for processing data. The weights 904 can belong to a class of device called a resistive processing unit (RPU). The RPU devices can be implemented with resistive random access memory (RRAM), phase change memory (PCM), programmable metallization cell (PMC) memory, or any other device that has non-linear resistive switching characteristics. Such RPU devices can also be considered as memristive systems.

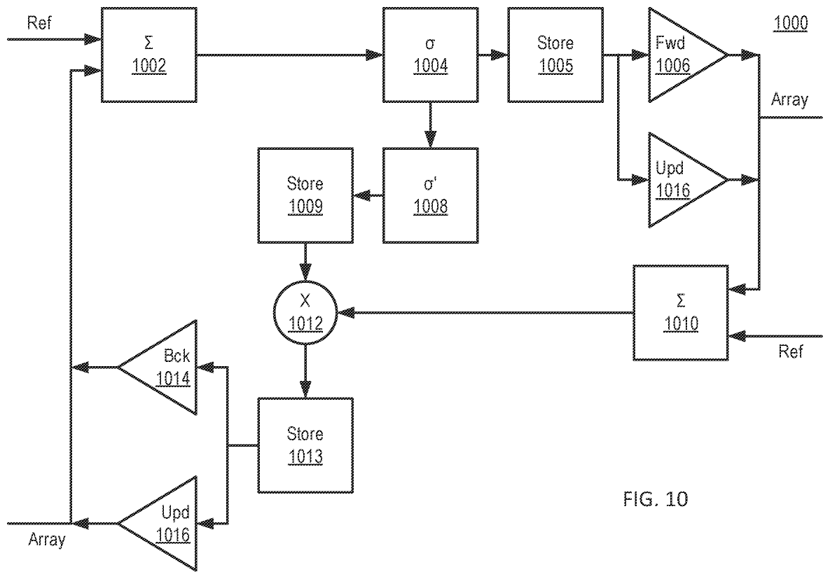

Referring now to FIG. 10, with continued reference to FIG. 9, a block diagram showing an exemplary neuron 1000 in a neural network for artificial intelligence-based automated data analysis, report/news article generation, and optimization, is illustratively depicted in accordance with an embodiment of the present invention.

In various embodiments, this neuron can represent any of the input neurons 902, the hidden neurons 906, or the output neurons 908, as shown in FIG. 9. It should be noted that FIG. 10 shows components to address all three phases of operation: feed forward, back propagation, and weight update. However, because the different phases do not overlap, there will necessarily be some form of control mechanism within in the neuron 1000 to control which components are active. It should therefore be understood that there can be switches and other structures that are not shown in the neuron 1000 to handle switching between modes, in accordance with aspects of the present invention.

In feed forward mode, a difference block 1002 determines the value of the input from the array by comparing it to the reference input. This sets both a magnitude and a sign (e.g., + or −) of the input to the neuron 1000 from the array. Block 1004 performs a computation based on the input, the output of which is stored in storage 1005. It is specifically contemplated that block 1004 computes a non-linear function and can be implemented as analog or digital circuitry or can be performed in software. The value determined by the function block 1004 is converted to a voltage at feed forward generator 1006, which applies the voltage to the next array. The signal propagates this way by passing through multiple layers of arrays and neurons until it reaches the final output layer of neurons. The input is also applied to a derivative of the non-linear function in block 1008, the output of which is stored in memory 1009.

During back propagation mode, an error signal is generated. The error signal can be generated at an output neuron 908 or can be computed by a separate unit that accepts inputs from the output neurons 908 and compares the output to a correct output based on the training data. Otherwise, if the neuron 1000 is a hidden neuron 906, it receives back propagating information from the array of weights 904 and compares the received information with the reference signal at difference block 1010 to provide a continuously valued, signed error signal. This error signal is multiplied by the derivative of the non-linear function from the previous feed forward step stored in memory 1009 using a multiplier 1012, with the result being stored in the storage 1013. The value determined by the multiplier 1012 is converted to a backwards propagating voltage pulse proportional to the computed error at back propagation generator 1014, which applies the voltage to the previous array. The error signal propagates in this way by passing through multiple layers of arrays and neurons until it reaches the input layer of neurons 902.

During weight update mode, after both forward and backward passes are completed, each weight 904 is updated proportional to the product of the signal passed through the weight during the forward and backward passes. The update signal generators 1016 provide voltage pulses in both directions (though note that, for input and output neurons, only one direction will be available). The shapes and amplitudes of the pulses from update generators 1016 are configured to change a state of the weights 904 (e.g., priority list weights, attribute weights for generating writing style/personalities, etc.), such that the resistance of the weights 904 is updated, in accordance with aspects of the present invention.

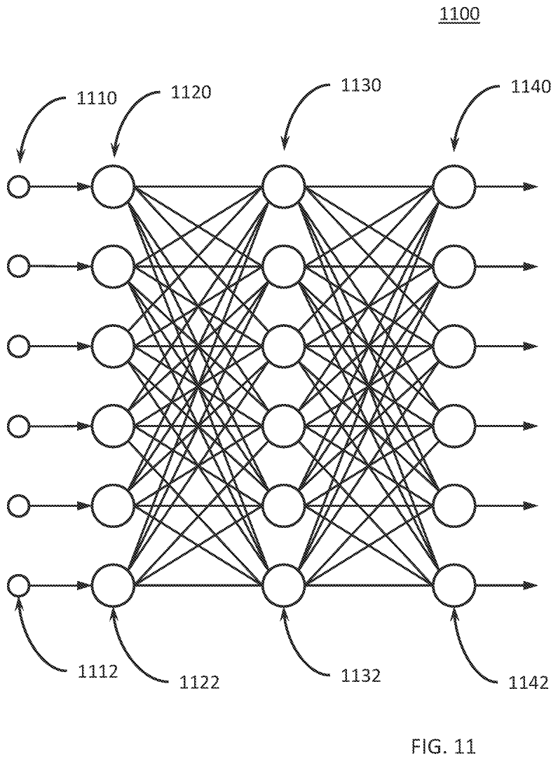

Referring now to FIG. 11, a diagram showing an exemplary layered neural network 1100 in a neural network for artificial intelligence-based automated data analysis, report/news article generation, and optimization, is illustratively depicted in accordance with an embodiment of the present invention.

In layered neural networks, nodes are arranged in the form of layers. An exemplary simple neural network has an input layer 1120 of source nodes 1122, and a single computation layer 1130 having one or more computation nodes 1132 that also act as output nodes, where there is a single computation node 1132 for each possible category into which the input example could be classified. An input layer 1120 can have a number of source nodes 1122 equal to the number of data values 1112 in the input data 1110. The data values 1112 in the input data 1110 can be represented as a column vector. Each computation node 1132 in the computation layer 1130 generates a linear combination of weighted values from the input data 1110 fed into input nodes 1120, and applies a non-linear activation function that is differentiable to the sum. The exemplary simple neural network can perform classification on linearly separable examples (e.g., patterns).

A deep neural network, such as a multilayer perceptron, can have an input layer 1120 of source nodes 1122, one or more computation layer(s) 1130 having one or more computation nodes 1132, and an output layer 1140, where there is a single output node 1142 for each possible category into which the input example could be classified. An input layer 1120 can have a number of source nodes 1122 equal to the number of data values 1112 in the input data 1110. The computation nodes 1132 in the computation layer(s) 1130 can also be referred to as hidden layers, because they are between the source nodes 1122 and output node(s) 1142 and are not directly observed. Each node 1132. 1142 in a computation layer generates a linear combination of weighted values from the values output from the nodes in a previous layer, and applies a non-linear activation function that is differentiable over the range of the linear combination. The weights applied to the value from each previous node can be denoted, for example, by w₁, W₂, . . . . Wₙ₋₁, Wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 1132 in the one or more computation (hidden) layer(s) 1130 perform a nonlinear transformation on the input data 1112 that generates a feature space. The classes or categories may be more easily separated in the feature space than in the original data space.

In various embodiments, the present invention can gather data (e.g., current events, scientific, etc.) about a particular event identified by utilizing, for example, social listening AIs (e.g., Yonder.ai, Aylien, etc.) from various sources in a combination of structured and unstructured data. This data can be fed into an NLP engine (e.g., local or remote) for further analysis. This NLP model can be pre-trained by developers to apply priority weights to category details described above with reference to the priority list through categorization, and can generate selectable writing style personalities for report generation based on pretraining and/or retraining, using a neural network, particular writing style attributes (e.g., verbose, witty, whimsical, serious, etc.) for use by the writing style/personality selectors, described in further detail above with regard to FIGS. 6A, 6B, 7A, and 7B, in accordance with aspects of the present invention. In addition to priority weights, the present invention can further analyze and structure the data for the next step, which can include processing all of the data for the particular event to an iteratively trained NLG to write the report/news article.

In some embodiments, an NLG can be pre-trained with personality weights, attributes, parameters, and other settings to produce text in a selected tone/writing style. Once the NLG receives sufficient information (e.g., satisfies all thresholds or a preselected number of thresholds, or an insufficient information alert has been received and overridden by a user), a report/news article draft can be generated. For example, a report/news article draft can be generated by first keeping within the word limit using priority 1 pieces of information first, then priority 2 if the word count cannot be satisfied from priority 1 information, and so on until a selected word length threshold is reached, after which the generated report/news article can be stored for future access for editing, publishing, etc., in accordance with aspects of the present invention.

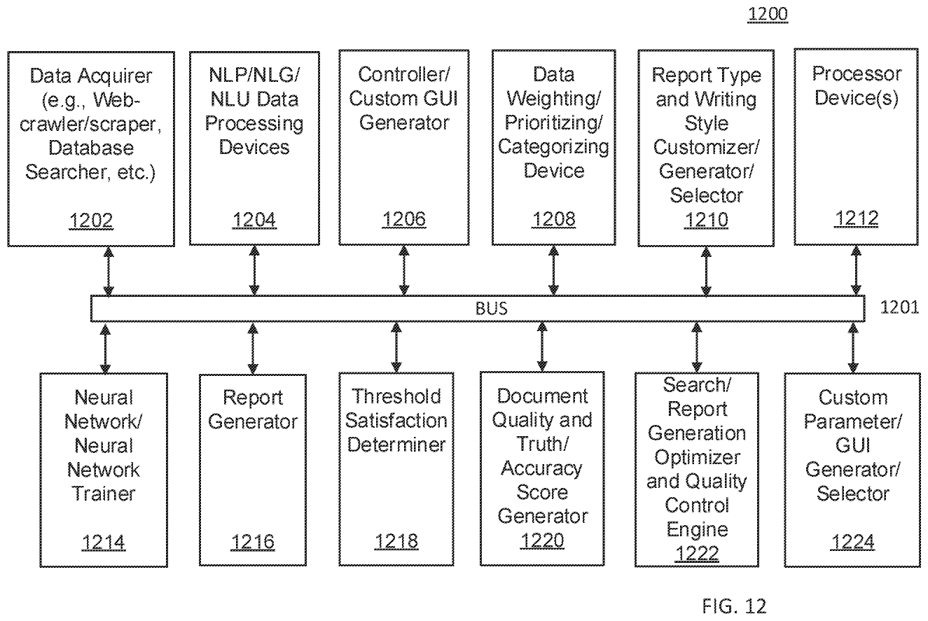

Referring now to FIG. 12, a block diagram showing a system 1200 for artificial intelligence-based data collection, analysis, optimization, and automated report/news article generation using a neural network and content acquired from a plurality of data sources, is illustratively depicted in accordance with an embodiment of the present invention.

In block 1202, data for one or more selected topics of interest can be acquired from any of a plurality of sources using, for example, a web-crawler, web-scraper, database searcher, etc., and relevant data to the topic of interest from the acquired data can be identified and processed using NLP techniques (e.g., NLU, sentiment analysis, named entity recognition, summarization, topic modeling, text classification, keyword extraction, lemmatization and stemming, etc.) in block 1204, in accordance with various aspects of the present invention.

In block 1204, a controller GUI 1206 and a processor device 1212 can be utilized to initiate this data to be fed into an NLP engine on, for example, Google Cloud for further analysis. In block 1208, data weighting, categorizing, and prioritizing of data can be performed, and this NLP model can be pre-trained to apply the priority weights to the category/priority details described above through categorization. In addition to priority weights, it can further analyze and structure the data for the next step. Finally, all of the data for the particular event can be sent to a NLG to write the article. The NLG can be pre-trained, or can be iteratively retrained using a neural network/neural network trainer in block 1214, with the personality weights and settings to produce text in an appropriate tone for selected constraints. Once the NLG receives all of the information and all threshold levels have been determined to be satisfied by a threshold satisfaction determiner in block 1218, it can generate a report/news article using a report/news article generator in block 1216 in accordance with selected parameters (e.g., keeping within the word limit using priority 1 pieces of information first, then priority 2, and so on until it reaches the desired word length), in accordance with aspects of the present invention.

In block 1220, a truth/accuracy score can be determined using a truth/accuracy score generator, and a search/report/news article generation optimizer 1222 can be utilized to iteratively train a neural network to optimize searching and report/news article generation functions, as described in further detail above, in accordance with aspects of the present invention. A custom parameter/GUI generator/selector 1224 can be utilized to generate customized GUI for different story types, tier levels, parameters, weights, etc., in accordance with aspects of the present invention.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for generating a report, comprising:
acquiring data for one or more topics of interest from a plurality of data sources;
extracting, prioritizing, and categorizing content from the acquired data into corresponding categories and subcategories based on a predetermined hierarchical set of priority rules;
selecting a writing style and one or more report threshold levels as constraints for generating a customized report based on the prioritized and categorized content;
iteratively generating a final report draft by generating one or more report drafts by sequentially utilizing the prioritized and categorized content from a highest priority level to a lowest priority level for the categories and subcategories until the one or more report threshold level constraints are reached; and
determining an overall quality score for the final report draft based on a category content accuracy score for each of the categories, the category content accuracy score being determined by calculating an average of subcategory content accuracy scores for each related subcategory.

2. The method as recited in claim 1, wherein the one or more topics of interest include current events, and the report is a current events news article.

3. The method as recited in claim 1, wherein the categories in the hierarchical set of priority rules are based on determining answers to investigative questions including who, what, where, when, how, and why for the one or more topics of interest.

4. The method as recited in claim 1, wherein each of the categories are assigned a unique priority level by a user.

5. The method as recited in claim 1, further comprising generating one or more writing styles based on a user selection of one or more of a plurality of writing style attributes.

6. The method as recited in claim 5, wherein the plurality of writing style attributes includes passive aggressive, active aggressive, verbose, terse, whimsical, passive, direct, technical, casual, funny, formal, and informative.

7. The method as recited in claim 5, wherein the generating one or more custom writing styles comprises combining one or more of the writing style attributes by selecting a percentage weight to apply for each of the one or more writing style attributes using corresponding sliders on a graphical user interface (GUI).

8. The method as recited in claim 1, further comprising generating an accuracy of content score and a detected plagiarism score by analyzing the final draft using natural language processing (NLP) techniques and iteratively generating one or more additional report drafts until a content score and detected plagiarism score threshold is reached.

9. A system for generating a report, comprising:
a processor operatively coupled to a computer-readable storage medium, the processor being configured for:
acquiring data for one or more topics of interest from a plurality of data sources;
extracting, prioritizing, and categorizing content from the acquired data into corresponding categories and subcategories based on a predetermined hierarchical set of priority rules;
selecting a writing style and one or more report threshold levels as constraints for generating a customized report based on the prioritized and categorized content;
iteratively generating a final report draft by generating one or more report drafts by sequentially utilizing the prioritized and categorized content from a highest priority level to a lowest priority level for the categories and subcategories until the one or more report threshold level constraints are reached; and
determining an overall quality score for the final report draft based on a category content accuracy score for each of the categories, the category content accuracy score being determined by calculating an average of subcategory content accuracy scores for each related subcategory.

10. The system as recited in claim 9, wherein the one or more topics of interest include current events, and the report is a current events news article.

11. The system as recited in claim 9, wherein the categories in the hierarchical set of priority rules are based on determining answers to investigative questions including who, what, where, when, how, and why for the one or more topics of interest.

12. The system as recited in claim 9, wherein each of the categories are assigned a unique priority level by a user.

13. The system as recited in claim 9, wherein the processor is further configured for generating one or more writing styles based on a user selection of one or more of a plurality of writing style attributes.

14. The system as recited in claim 13, wherein the plurality of writing style attributes includes passive aggressive, active aggressive, verbose, terse, whimsical, passive, direct, technical, casual, funny, formal, and informative.

15. The system as recited in claim 13, wherein the generating one or more custom writing styles comprises combining one or more of the writing style attributes by selecting a percentage weight to apply for each of the one or more writing style attributes using corresponding sliders on a graphical user interface (GUI).

16. The system as recited in claim 9, wherein the processor is further configured for generating an accuracy of content score and a detected plagiarism score by analyzing the final draft using natural language processing (NLP) techniques and iteratively generating one or more additional report drafts until a content score and detected plagiarism score threshold is reached.

17. A non-transitory computer readable storage medium comprising a computer readable program operatively coupled to a processor device for generating a report, wherein the computer readable program when executed on a computer causes the computer to perform steps of:
acquiring data for one or more topics of interest from a plurality of data sources;
extracting, prioritizing, and categorizing content from the acquired data into corresponding categories and subcategories based on a predetermined hierarchical set of priority rules;
selecting a writing style and one or more report threshold levels as constraints for generating a customized report based on the prioritized and categorized content;
iteratively generating a final report draft by generating one or more report drafts by sequentially utilizing the prioritized and categorized content from a highest priority level to a lowest priority level for the categories and subcategories until the one or more report threshold level constraints are reached; and
determining an overall quality score for the final report draft based on a category content accuracy score for each of the categories, the category content accuracy score being determined by calculating an average of subcategory content accuracy scores for each related subcategory.

18. The non-transitory computer readable storage medium of claim 17, wherein the categories in the hierarchical set of priority rules are based on determining answers to investigative questions including who, what, where, when, how, and why for the one or more topics of interest.

19. The non-transitory computer readable storage medium of claim 17, wherein the categories in the hierarchical set of priority rules are based on determining answers to investigative questions including who, what, where, when, how, and why for the one or more topics of interest, and each of the categories are assigned a unique priority level by a user.

20. The non-transitory computer readable storage medium of claim 17, further comprising:
generating one or more writing styles based on a user selection of one or more of a plurality of writing style attributes, including passive aggressive, active aggressive, verbose, terse, whimsical, passive, direct, technical, casual, funny, formal, and informative, the generating one or more writing styles further comprising combining one or more of the writing style attributes by selecting a percentage weight to apply for each of the one or more writing style attributes using corresponding selectors on a graphical user interface (GUI).
